(19) United States
(12) Patent Application Publication
(10) Pub. No.: US 2006/0104735 A1
(43) Pub. Date: May 18, 2006

(54) Tool and accessory connecting system

(76) Inventors: Jeffrey M. Zeiler, Delafield, WI (US); Thomas P. James, Oconomowoc, WI (US); Pamela S. Stegehuis, Helenville, WI (US); David A. Hempe, Wauwatosa, WI (US); Burton E. Yanke, Menomonee Falls, WI (US)

Correspondence Address: MICHAEL BEST & FRIEDRICH, LLP, 100 E WISCONSIN AVENUE, MILWAUKEE, WI, 53202, US

(21) Appl. No.: 10/389,070

(22) Filed: Mar. 14, 2003

Related U.S. Application Data
(60) Provisional application No. 60/364,693, filed on Mar. 15, 2002.

(51) Int. Cl. B23B 39/00; A45F 5/00; E21B 17/22; H02J 7/00

(52) U.S. Cl. 408/241 R; 224/269; 173/217; 320/114

(57) ABSTRACT

Carrying systems, connecting systems and methods. The system connects a power tool and a component. In some constructions and in some aspects, the power tool includes a housing and a U-shaped receptacle defined by the housing. In some constructions and in some aspects, the component includes a stud selectively engageable with the receptacle to connect the power tool and the component. A locking mechanism is positioned within the receptacle and includes a cam. The locking mechanism is engageable with the stud to restrict movement of the stud with respect to the receptacle. The stud includes a recess at an end of the stud. The cam is selectively engageable with the recess to retain the stud within the receptacle. The cam is movable between a lock position and a released position. In the locked position, the cam extends into the recess and engages the stud. In the released position, the cam is retracted from the recess and is disengaged with the stud.

### RELATED APPLICATIONS

The present application claims the benefit of prior-filed co-pending provisional patent application Ser. No. 60/364,693, filed Mar. 15, 2002.

### FIELD OF THE INVENTION

This invention relates to power tools and power tool accessories and, more particularly, to a connecting system for power tools and accessories.

### BACKGROUND OF THE INVENTION

Power tools are used to for various operations including sawing and drilling. In between or during such operations, the operator may want to carry the tool “hands-free”, or to store the tool temporarily so that other operations can be performed with both hands.

### SUMMARY OF THE INVENTION

Some tool holsters are relatively large to accommodate the tool. Also, the holster (with and without the tool) is unwieldy and burdensome and get in the way of the operator.

Some existing tool holders require moving parts and may be relatively heavy. Also, the cradling devices project from an operator's work belt and may get in the way and hinder movement of the operator.

With some existing holding devices formed on the tool, the projections are an impediment and may catch on loose clothing or objects around the work site. Also, the projections may be inconvenient for the operator to use.

Some existing devices cannot be used to connect accessories to the tool.

The present invention provides a connecting or carrying system which substantially alleviates one or more of the above-identified and other problems with existing power tool and/or accessory connecting or carrying devices. Generally, the system of the present invention connects two components, such as, for example, a power tool to a belt clip or an accessory to a power tool and/or to a belt clip. In the illustrated construction and in some aspects, the system includes cooperating connectors, such as a receptacle formed on one of the components and a stud formed on the other of the components, and the connectors are engageable to connect the components. The system may include a releasable locking mechanism for selectively preventing connectors from being disconnected (i.e., the stud from being disengaged from the receptacle).

More particularly, in some aspects, the present invention provides a combination including a power tool and a belt clip. The belt clip is connectable to a work belt. One of the power tool and the belt clip defines a receptacle, and the other of the power tool and the belt clip includes the stud. The stud is engageable in the receptacle to connect the power tool to the belt clip.

The combination may also include a locking mechanism for selectively locking the power tool to the belt clip in the engaged position. The locking mechanism may include a cam or locking member positioned in the receptacle and engageable with the stud to lock the stud in the receptacle in the engaged position. The locking mechanism may include an actuator or button operable to move the cam out of engagement with the stud so that the stud is released and removable from the receptacle to disconnect the power tool and the belt clip. Insertion of the stud into the receptacle may cause the cam to move to a release position until the stud is fully inserted into the receptacle, and a spring may bias the cam toward the locking position so that the cam engages the stud.

The power tool may include a housing having a removable housing portion. The combination may include a replaceable housing portion including the one of the receptacle and the stud provided by the power tool. The replaceable housing portion is substitutable for the removable housing portion so that the power tool is connectable to the belt clip.

Also, in some aspects, the present invention provides a combination including a power tool and a power tool accessory. One of the power tool and the accessory defines a receptacle, and the other of the power tool and the accessory includes the stud. The stud is engageable in the receptacle to connect the power tool to the accessory.

In addition, in some aspects, the present invention provides a combination including a power tool accessory and a belt clip. One of the power tool accessory and the belt clip defines a receptacle, and the other of the power tool accessory and the belt clip includes the stud. The stud is engageable in the receptacle to connect the power tool accessory to the belt clip.

Further, in some aspects, the present invention provides a combination including a power tool accessory, a belt clip and an adapter. The power tool accessory and the belt clip each define one of a receptacle a stud. The adapter defines a first one of the other of the receptacle and the stud and a second one of the other of the receptacle and the stud. The adapter is connectable between the power tool accessory and the belt clip to connect the power tool accessory to the belt clip.

Also, in some aspects, the present invention provides a combination including a power tool, a power tool accessory, a belt clip and an adapter. The power tool defines a receptacle, and the belt clip includes a clip stud. The clip stud is engageable in the receptacle to connect the power tool to the belt clip. The accessory also includes an accessory stud, and the accessory stud is engageable in the receptacle to connect the accessory to the power tool. The adapter defines a first adapter receptacle and a second adapter receptacle. To connect the accessory to the belt clip, the clip stud is engageable in the first adapter receptacle, and the accessory stud is engageable in the second adapter receptacle.

In some aspects, the carrying system of the present invention permits the operator to connect a power tool to the belt clip for various periods of time while conveniently maintaining the power tool within reach. The connectors, such as the stud and the receptacle, are relatively small and non-obtrusive, preventing the carrying system from getting in the way of the operator. In one construction, the receptacle may be incorporated into the body of the tool. Preferably, the receptacle does not protrude from the tool to help prevent the tool from catching on objects or clothing.

In some aspects, the carrying system may include power tool accessories, such as, for example, a light, a bubble level or a bit holder, which may be connected to the power tool to assist the operator and for easy access. The power tool may include multiple connectors to connect to both a power tool accessory and the belt clip or to multiple accessories. The accessory interconnected to the tool is readily available for the operator. The carrying system may also include an adapter to interconnect the accessory to the belt clip. The operator may have multiple belt clips for carrying multiple tools and multiple accessories simultaneously.

In some aspects and in some constructions, the connecting system may include a power tool and a component removably connectable with the power tool. The power tool may include a connecting portion having a first aperture, a second aperture, and a locking aperture. The component may include a first leg engageable with the first aperture, a second leg engageable with the second aperture, and a locking member engageable with the locking aperture. The component may be movable in a direction substantially parallel to the connecting portion between a locked position, in which the locking member is secured within the locking aperture, and an unlocked position, in which the locking member is removable from the locking aperture.

In some aspects, the component includes a retainer defining a receptacle with the connecting portion. The power tool and retainer are connectable to an attachment member having a stud engageable with the receptacle. The attachment member may include a locking mechanism that secures the stud within the receptacle. The power tool may include a recess in the connecting portion, and the attachment member may include a pin extending from the end of the stud that is engageable with the recess. The pin may be movable between a locked position, in which the pin engages the recess, and an unlocked position, in which the pin is retracted into the stud. The pin may be biased toward the locked position, and the locking mechanism may include a release mechanism to move the pin toward the unlocked position.

The attachment member may also include a clip to connect the attachment member to a support, such as a work belt. In some aspects, the clip may include a clip surface on a body of the attachment member, and a clip jaw movable relative to the clip surface. The clip may include an extension pin extending from the clip jaw into the body, and a clip locking mechanism selectively engageable with the extension pin to restrict movement of the clip jaw relative to the clip surface. In some aspects, the clip may include a flexible clip jaw connected to the body of the attachment member.

In some aspects, the component may include other power tool accessories, such as a bit holder, bubble level or light, removably connectable with the power tool. The accessory is interchangeable with the component, and may include a first leg, second leg, and locking member, similar to the component. In other aspects and in other constructions, the power tool may include multiple connecting portions, and may be connectable with one or more components. For example, the power tool may be connected to a retainer on a first connecting portion, and a bit holder on a second connecting portion.

Independent features and independent advantages of the present invention will become apparent to those skilled in the art upon review of the following detailed description, claims and drawings.

### BRIEF DESCRIPTION OF THE DRAWINGS

FIG. 1 is a perspective view of a belt clip embodying aspects of the invention.

FIG. 2 is a perspective view of a power tool embodying aspects of the invention.

FIG. 3 is an elevation view of the power tool of FIG. 2.

FIG. 4 is a perspective view of a power tool accessory, such as a light, embodying aspects of the invention.

FIG. 5 is a perspective view of another power tool accessory, such as a bit holder, embodying aspects of the invention.

FIG. 6 is an elevation view of an adapter embodying aspects of the invention.

FIG. 7 is an elevation view of the adapter of FIG. 6.

FIG. 8 is an elevation view of a power tool embodying aspects of the invention.

FIG. 9 is an elevation view of a power tool embodying aspects of the invention.

FIG. 10 is an elevation view of a work light embodying aspects of the invention.

FIG. 11 is a perspective view of a power tool and a component embodying aspects of the invention.

FIG. 12 is a perspective view of the power tool and component of FIG. 11.

FIG. 13 is a top view of the power tool and component of FIG. 11.

FIG. 14 is a side view of the power tool and component of FIG. 11.

FIG. 15 is rear view of the power tool and component of FIG. 11.

FIG. 16 is a side view of the power tool and component of FIG. 11.

FIG. 17 is a perspective view of a power tool embodying aspects of the invention.

FIG. 18 is an enlarged view of a portion of the power tool of FIG. 17.

FIG. 19 is a top view of the power tool of FIG. 17.

FIG. 20 is a side view of the power tool of FIG. 17.

FIG. 21 is a rear view of the power tool of FIG. 17.

FIG. 22 is a side view of the power tool of FIG. 17.

FIG. 23 is a perspective view of a power tool and a battery embodying aspects of the invention.

FIG. 24 is a perspective view of the power tool and battery of FIG. 23.

FIG. 25 is a top view of the power tool and battery of FIG. 23.

FIG. 26 is a side view of the power tool and battery of FIG. 23.

FIG. 27 is a rear view of the power tool and battery of FIG. 23.

FIG. 28 is a side view of the power tool and battery of FIG. 23.

FIG. 29 is a perspective view of a portion of a power tool and a component embodying aspects of the invention and illustrating the component removed from the power tool.

FIG. 30 is a perspective view of the power tool and component of FIG. 29 and illustrating the component at least partially engaged with the power tool.

FIG. 31 is a perspective view of the power tool and component of FIG. 29 and illustrating the component in an unlocked position.

FIG. 32 is a perspective view of the power tool and component of FIG. 29 and illustrating the component in a locked position.

FIG. 33 is a perspective view of a component embodying aspects of the invention.

FIG. 34 is a perspective view of the component of FIG. 33.

FIG. 35 is a top view of the component of FIG. 33.

FIG. 36 is an end view of the component of FIG. 33.

FIG. 37 is a side view of the component of FIG. 33.

FIG. 38 is an end view of the component of FIG. 33.

FIG. 39 is a side view of the component of FIG. 33.

FIG. 40 is a bottom view of the component of FIG. 33.

FIG. 41 is a perspective view of a component embodying aspects of the invention.

FIG. 42 is a perspective view of the component of FIG. 41.

FIG. 43 is a perspective view of the component of FIG. 41 and illustrating the component retaining bits.

FIG. 44 is a top view of the component of FIG. 41.

FIG. 45 is an end view of the component of FIG. 41.

FIG. 46 is a side view of the component of FIG. 41.

FIG. 47 is an end view of the component of FIG. 41.

FIG. 48 is a side view of the component of FIG. 41.

FIG. 49 is a bottom view of the component of FIG. 41.

FIG. 50 is a perspective view of a component embodying aspects of the invention.

FIG. 51 is a perspective view of the component of FIG. 50.

FIG. 52 is a top view of the component of FIG. 50.

FIG. 53 is an end view of the component of FIG. 50.

FIG. 54 is a side view of the component of FIG. 50.

FIG. 55 is an end view of the component of FIG. 50.

FIG. 56 is a side view of the component of FIG. 50.

FIG. 57 is a bottom view of the component of FIG. 50.

FIG. 58 is a perspective view of a component embodying aspects of the invention.

FIG. 59 is a perspective view of the component of FIG. 58.

FIG. 60 is a perspective view of the component of FIG. 58 and illustrating the component retaining a light.

FIG. 61 is a top view of the component of FIG. 58.

FIG. 62 is an end view of the component of FIG. 58.

FIG. 63 is a side view of the component of FIG. 58.

FIG. 64 is an end view of the component of FIG. 58.

FIG. 65 is a side view of the component of FIG. 58.

FIG. 66 is a bottom view of the component of FIG. 58.

FIG. 67 is a perspective view of an attachment member embodying aspects of the invention.

FIG. 68 is a perspective view of the attachment member of FIG. 67.

FIG. 69 is a perspective view of the attachment member of FIG. 67 having a belt hook.

FIG. 70 is a perspective view of the attachment member of FIG. 69.

FIG. 71 is an assembly view of the attachment member of FIG. 69.

FIG. 72 is a perspective view of an attachment member embodying aspects of the invention.

FIG. 73 is a perspective view of the attachment member of FIG. 72.

FIG. 74 is a side view of the attachment member of FIG. 72.

FIG. 75 is a side view of the attachment member of FIG. 72.

FIG. 76 is a side view of the attachment member of FIG. 72.

FIG. 77 is a bottom view of the attachment member of FIG. 72.

FIG. 78 is a bottom view of the attachment member of FIG. 72.

FIG. 79 is a bottom view of the attachment member of FIG. 72.

FIG. 80 is a perspective view of an attachment member embodying aspects of the invention.

FIG. 81 is a perspective view of the attachment member of FIG. 80.

FIG. 82 is a side view of the attachment member of FIG. 80.

FIG. 83 is a side view of the attachment member of FIG. 80.

FIG. 84 is a side view of the attachment member of FIG. 80.

FIG. 85 is a bottom view of the attachment member of FIG. 80.

FIG. 86 is a bottom view of the attachment member of FIG. 80.

FIG. 87 is a bottom view of the attachment member of FIG. 80.

FIG. 88 is a side view of an attachment member embodying aspects of the invention.

FIG. 89 is a top view of the attachment member of FIG. 88 in a locked position.

FIG. 90 is a top view of the attachment member of FIG. 88 in an unlocked position.

Before any constructions of the invention are explained in detail, it is to be understood that the invention is not limited in its application to the details of construction and the arrangements of components set forth in the following description or illustrated in the drawings. The invention is capable of other constructions and of being practiced or of being carried out in various ways. Also, it is to be understood that the phraseology and terminology used herein is for the purpose of description and should not be regarded as limiting.

Although references may be made below to directions, such as left, right, up, down, top, bottom, front, rear, back, etc., in describing the drawings, these references are made relative to the drawings (as normally viewed) for convenience. These directions are not intended to be taken literally or to limit the present invention in any form.

### DETAILED DESCRIPTION

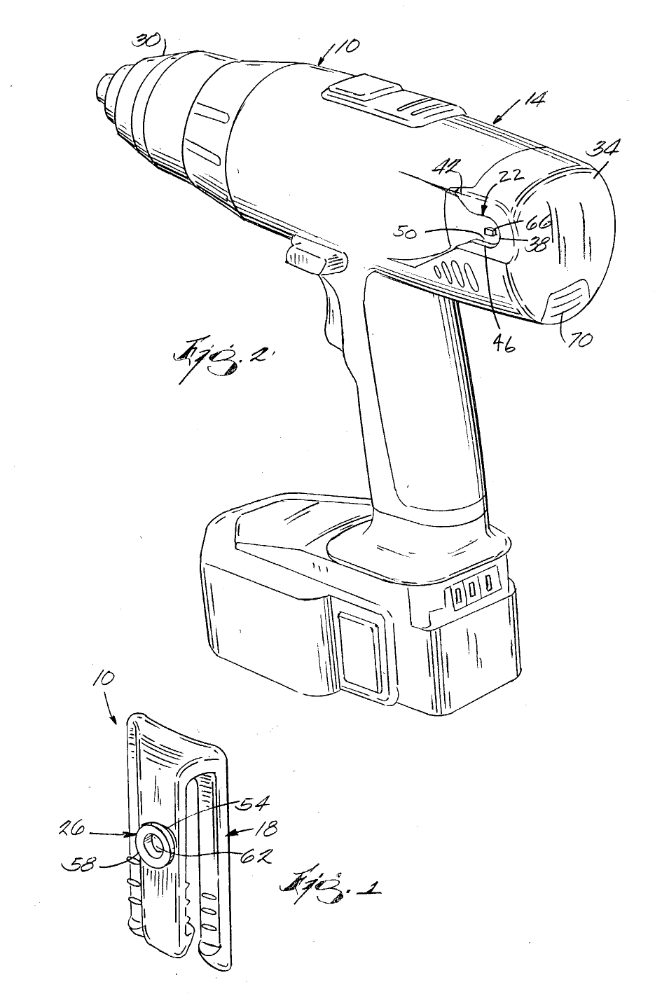

FIGS. 1 and 2 illustrate a carrying system 10 for a power tool 14. The carrying system 10 may be used to interconnect the power tool 14 to a component. In the illustrated construction, the component includes a belt clip 18, and the power tool 14 may be connected to the belt clip 18 for hands free support and retention of the power tool 14 on the belt clip 18. The carrying system 10 includes cooperating connectors, such as, in the illustrated construction, a receptacle 22 and a stud 26, which are detachably interconnected with each other. In the illustrated construction, the receptacle 22 is incorporated into the body of the power tool 14, and the stud 26 is incorporated into the belt clip 18.

The power tool 14 includes a forward portion 30 and a rearward portion 34. In the illustrated construction, the power tool 14 includes a drill, and a tool holder or chuck is disposed near the forward portion 30. In the illustrated construction, the receptacle 22 includes a recessed slot or groove incorporated into the body of the power tool 14. The receptacle 22 is substantially U-shaped, and has a closed end 38 and an open end 42. The open end 42 opens toward the forward portion 30, and the closed end 38 is adjacent the rearward portion 34 of the power tool 14. The receptacle 22 may include a ridge 46 near the edges of the receptacle 22, at least partially outlining the receptacle 22. The depth of the receptacle 22 may increase as the receptacle 22 progresses rearward from the open end 42 to the closed end 38. Preferably, there is an undercut portion 50 that extends along the ridge 38 within the receptacle 22.

In the illustrated construction, the receptacle 22 is integrally formed with the body of the power tool 14 and is recessed from the surface. Therefore, the carrying system 10 does not include elements that protrude from surface of the power tool 14 and could catch on other objects or clothing. The relatively smooth, streamlined configuration of the receptacle 22 enhances the convenience of the carrying system 10.

In other constructions, the power tool 14 may include a housing having a standard removable housing portion (not shown) without a receptacle. A new replaceable housing portion (not shown) including a receptacle (such as the receptacle 22) may be provided. The replaceable housing portion is substitutable for the removable housing portion so that the power tool 14 is connectable to the belt clip 18.

In the illustrated construction, the stud 26 is substantially round and projects outwardly from the belt clip 18, which may be connectable to a person's belt. The stud 26 includes a stem 54 that extends axially from the belt clip 18, and a head 58 at the end of the stem 54. The head 58 extends radially outwardly from the stem 54. The stem 54 and the head 58 are substantially circular, and the diameter of the head 58 is greater than the diameter of the stem 54. The stud 26 may include a recess 62 at an end of the stud 26. The recess 62 includes a concave indentation near the middle of the head 58.

The stud 26 engages the receptacle 22 to interconnect the power tool 14 to the belt clip 18. The stud 26 is slid into the receptacle 22 through the open end 42. The head 58 extends into the undercut portion 50 behind the ridge 46. The width of the ridge 46 near the closed end 38 is less than the diameter of the head 58 and greater than the diameter of the stem 54. In the illustrated construction, the stud 26 may engage the receptacle 22 while moving in a radial direction, but not an axial direction.

The carrying system 10 may include a locking mechanism for selectively releasably locking the connectors. The locking mechanism includes a locking member or cam 66 which operates to retain the stud 26 within the receptacle 22. The cam 66 is positioned in the receptacle 22 and may be spring-biased. The cam 66 is biased toward a locking position, in which the cam 66 engages the recess 62 on the head 58 of the stud 26. As the stud 26 slides into the receptacle 22, the head 58 depresses the cam 66 as the head 58 moves past the cam 66. When the recess 62 is aligned with the cam 66, the biased cam 66 returns to the locking position, extending into the recess 62. The cam 66 secures the stud 26 within the receptacle 22, helps prevent the stud 26 from inadvertently sliding out of the receptacle 22, and locks the power tool 14 to the belt clip 18.

The cam 66 may include a slanted surface facing the open end 42 of the receptacle 22 to facilitate moving the stud 26 past the cam 66 as the stud 26 is inserted into the receptacle 22. The cam 66 may also include a straight surface facing the closed end 38 of the receptacle 22 to engage the recess 62 and restrict movement of the stud 26 relative to the receptacle 22. Alternatively, the head 58 may include a slanted surface near the end of the stud 26 to facilitate moving the stud 26 past the cam 66 as the stud 26 is inserted into the receptacle 22. A side wall of the recess 62 may extend in a straight axial direction to engage the cam 66 and restrict movement of the stud 26 relative to the receptacle.

The power tool 14 may include a release mechanism or actuator which moves or retracts the cam 66 against the biasing force. In the illustrated construction, the release mechanism is a button 70 disposed near the rearward portion 34 of the power tool 14. The button 70 is positioned such that the operator gripping the handle of the power tool 14 may easily move his/her thumb to actuate the button 70 near the rearward portion 34. When the button 70 is depressed, the cam 66 retracts from the recess 62 and releases the stud 26 so the stud 26 may be removed from the receptacle 22. The button 70 is depressed to disengage the power tool 14 from the belt clip 18.

In the illustrated construction, the cam 66 is selectively engageable with the recess 62 to retain the stud 26 within the receptacle 22. The cam 66 is movable between a locked position, in which the cam 66 extends into the recess 62, and a released position, in which the cam 66 is retracted from the recess 62 and the stud 26 is removable from the receptacle 22. In the illustrated construction, the cam 66 is biased toward the locked position. The button 70 may be actuated to move the cam 66 toward the released position.

In FIGS. 1-3, the carrying system 10 is illustrated with the power tool 14 having the receptacle 22 and the belt clip 18 having the stud 26. It should be understood that, in other constructions (not shown), the stud 26 and receptacle 22 could be reversed, with the stud 26 projecting from the power tool 14, and the receptacle 22 being defined by the belt clip 18.

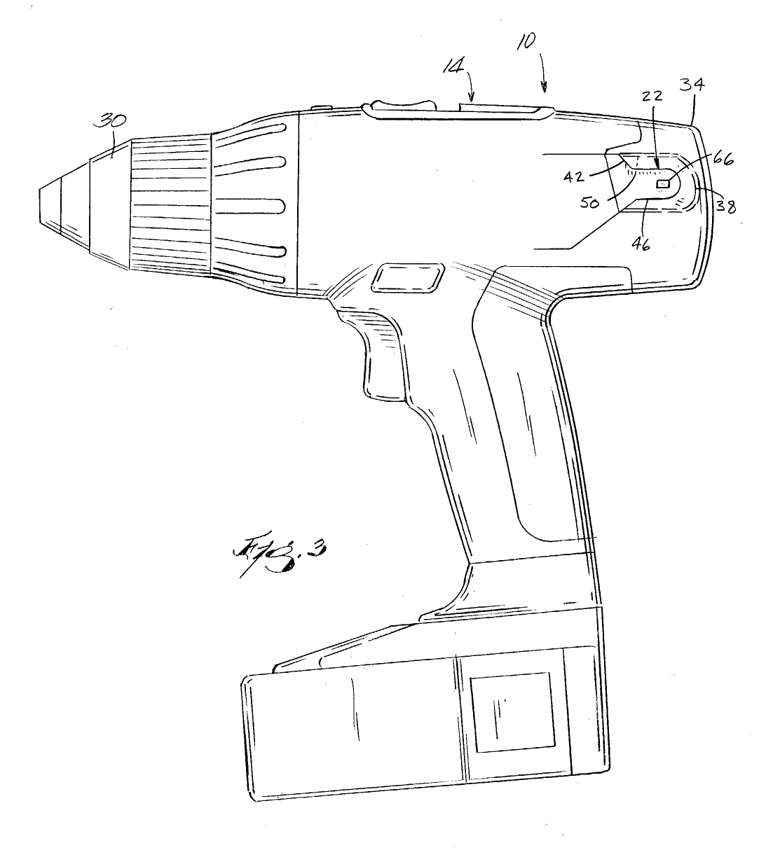

While in the illustrated construction, the power tool 14 includes a drill, it should be understood that, in other constructions (not shown), the power tool 14 may be, for example, a reciprocating saw, other saw, hammer drill, sander, router, impact wrench, light, or other similar power tool and power tool accessories. The power tool 14 may also be cordless (as shown in FIGS. 2 and 3) or may be a corded power tool.

In FIGS. 2 and 3, the receptacle 22 is formed integral with the body of the power tool 14. As discussed above, the power tool 14 may also be retrofitted to include a connector, such as the receptacle 22, and replacement portions of the housing of the power tool 14 may be installed near the rearward portion 34 including the receptacle 22. Alternatively, an additional cap (not shown) including a receptacle 22 may be positioned over the existing body of the power tool 14 near the rearward portion 34. The cap may be somewhat elastic and slipped over the rearward portion 34 to use the elastic properties to hold the cap in place. The cap may also be relatively rigid and fastened to the rearward portion 34. The retro-fit cap may include the cam 66 and the thumb button 70.

In the illustrated construction, the stud 26 is interconnected to a belt clip 18 which slips over a work belt or other supporting structure. Various configurations of the belt clip 18 and stud 26 may be used, and the belt clip 18 may require the belt to be inserted through an aperture on the belt clip 18. The stud 26 may also be directly incorporated into a tool work belt, as opposed to being a separate attachment on the belt. Additionally, the stud 26 may be interconnected to an object readily available for a tool operator, such as, for example, a ladder, scaffold, lift, tool chest, work bench, vehicle or other similar structure or place in which the power tool 14 may be used. The stud 26 may include an attachment, such as a strap, mounting bracket, or other fastening member, to interconnect the stud 26 to these work-related objects. It should be understood that the belt clip 18 merely illustrates one possible construction of a component removably connectable with the power tool 14.

FIGS. 2 and 3 illustrate the receptacle 22 on one side of the power tool 14. The power tool 14 may include the receptacle 22 on either side of the power tool 14, or on both sides of the power tool 14. The power tool 14 may also include multiple receptacles 22 on a single side of the power tool 14. As shown in FIGS. 2 and 3, the receptacle 22 would be on the inner side near the belt for right-handed operator. The power tool 14 having the receptacle 22 on both sides could accommodate both a right-handed and a left-handed operator.

The receptacle 22 may also be used to connect an accessory 74 to the power tool 14. In FIG. 4, the accessory 74 is a light 78 having a stud 82 that may be connected to the receptacle 22 of the power tool 14. The light 78 provides a light source and may be battery powered. Many applications for the power tool 14 may require an additional light source, such as a flash light, near a work area. Traditionally, the operator may hold the flash light in one hand, and the power tool 14 in the other hand. The stud 82 of the light 78 may engage the receptacle 22 to connect the light 78 to the power tool 14 and provide the operator with a free hand. The operator may hold the power tool 14 with both hands and provide greater control over the power tool 14. Even when not in use, the light 78 interconnected to the power tool 14 is readily available for any desired application requiring a light source.

In FIG. 5, the accessory 74 is a bit holder 86 having a stud 90 that may be interconnected to the receptacle 22 of the power tool 14. A tool operator may require multiple sized drill bits or screw driver bits for various applications. The bit holder 86 may hold multiple bits interconnected to the power tool 14 that the operator may access easily. The bit holder 86 helps the operator save time and effort by storing the bits in a convenient location. As mentioned above, the power tool 14 could include other power tools besides a drill, such as a saw or impact wrench. With other tools, the bit holder 86 may hold other similar attachments, such as saw blades for a saw or socket heads for an impact wrench.

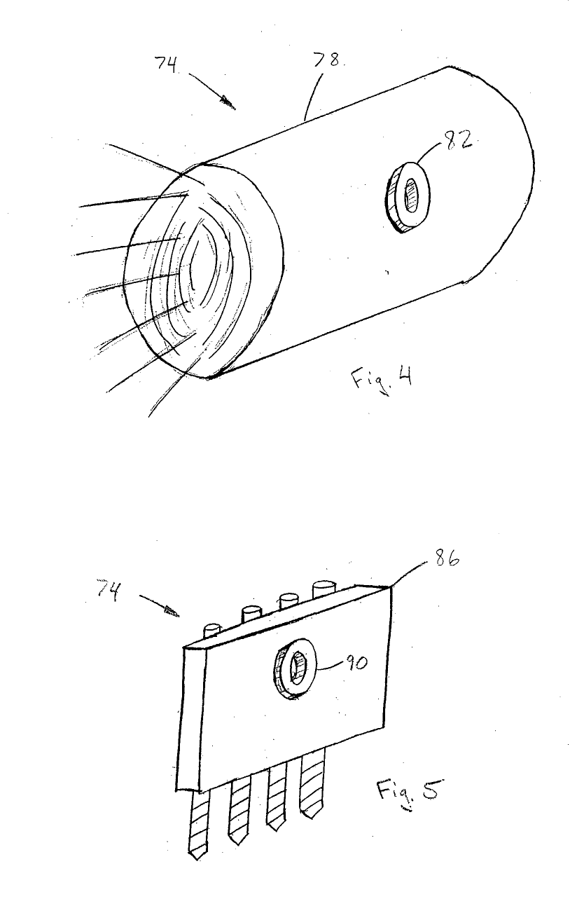

As shown in FIGS. 4 and 5, the light 78 and the bit holder 86 include studs 82, 90 that engage the receptacle 22 on the power tool 14. In FIGS. 6 and 7, the carrying system 10 may include an adapter 94 having two receptacles 98. The adapter 94 permits the accessory 74 (the light 78, the bit holder 86, etc.) to be interconnected to the belt clip 18. The stud 82, 90 from the light 78 or bit holder 86 may engage one of the receptacles 98 on the adapter 94, and the other receptacle 98 on the adapter 94 may engage the stud 26 on the belt clip 18. The operator may have multiple belt clips 18, and the power tool 14, light 78, bit holder 86, or other accessories 74 may be simultaneously interconnected to multiple belt clips 18 on the operator's belt. The multiple belt clips may include belt clips 18 having studs, and belt clips (not shown) having receptacles.

On the adapter 94, each receptacle 98 may be similar to the receptacle 22 described above, and may include a biased cam 102 and a button 106. The button 106 may actuate both cams 102. The cam 102 engages the stud 26, 82, 90 and may lock the power tool 14, accessory 74, or belt clip 18 into position.

Alternatively, in other constructions (not shown), the accessory may include a receptacle engageable with the stud 26 on the belt clip 18. Therefore, the accessory may not need the adapter 94 to engage the belt clip 18. For the accessory with the receptacle, the carrying system 10 may include an adapter having two studs (not shown) to interconnect the accessory 74 to the power tool 14. The studs of the adapter may engage the receptacle on the accessory and the receptacle 22 of the tool 10.

In other constructions (not shown), the tool may include a stud, and the belt clip may include a receptacle. With this configuration, the accessory having the receptacle may engage the stud on the tool, and the adapter having two studs may be used to interconnect the accessory to the belt clip. Also, the accessory may include a stud engageable with the receptacle of the belt clip, and the adapter may include two receptacles engageable with the stud of the power tool and the stud of the accessory.

The connecting system may implement various other combinations of the engageable studs and receptacles on the power tool, belt clip, accessories, adapters, and other components to connect the various components. In yet other constructions (not shown), the power tool and the belt clip may both include receptacles, and an accessory may include a stud engageable with the receptacles. An adapter having two studs may connect the power tool and the belt clip. Alternatively, the power tool and the belt clip may both include studs, and an accessory may include a receptacle engageable with the studs. An adapter having two receptacles may connect the power tool and the belt clip. The connecting system may also include one or more belt clips having receptacles and/or studs to connect the various combinations of power tools, accessories, adapters, and other components.

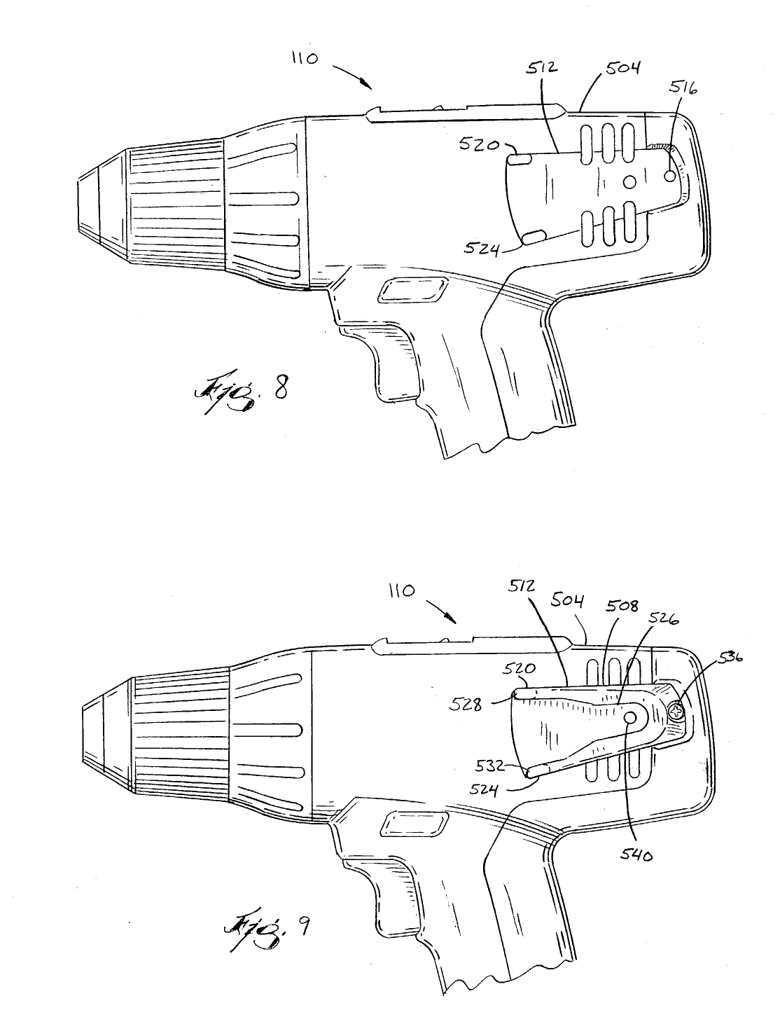

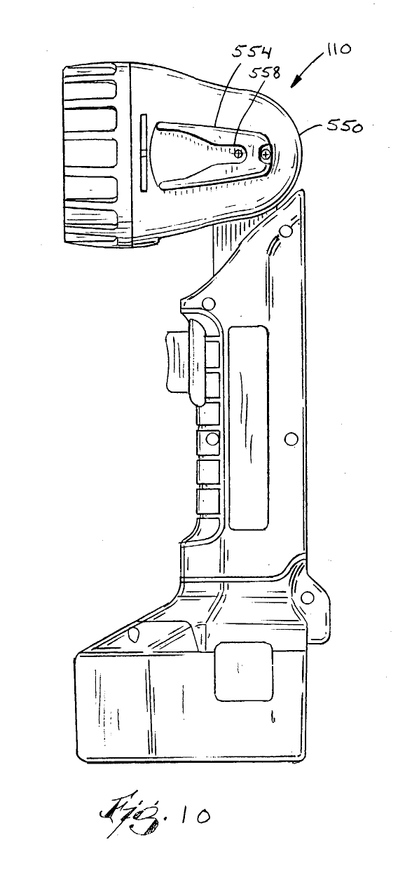

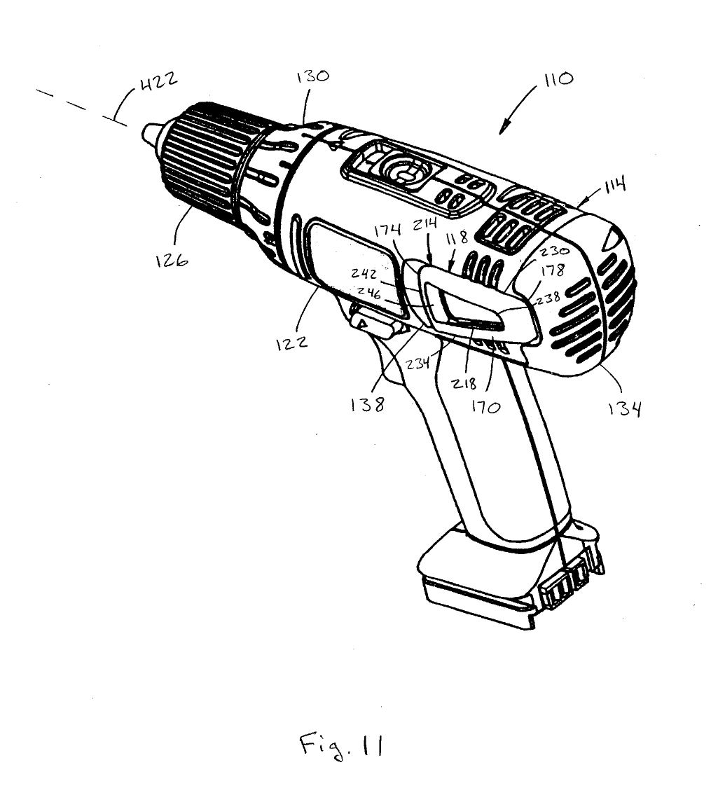

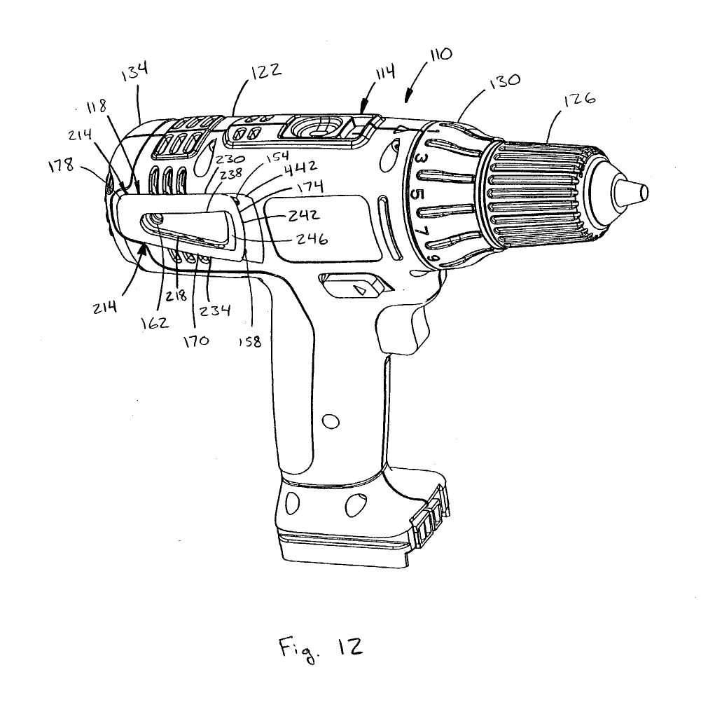

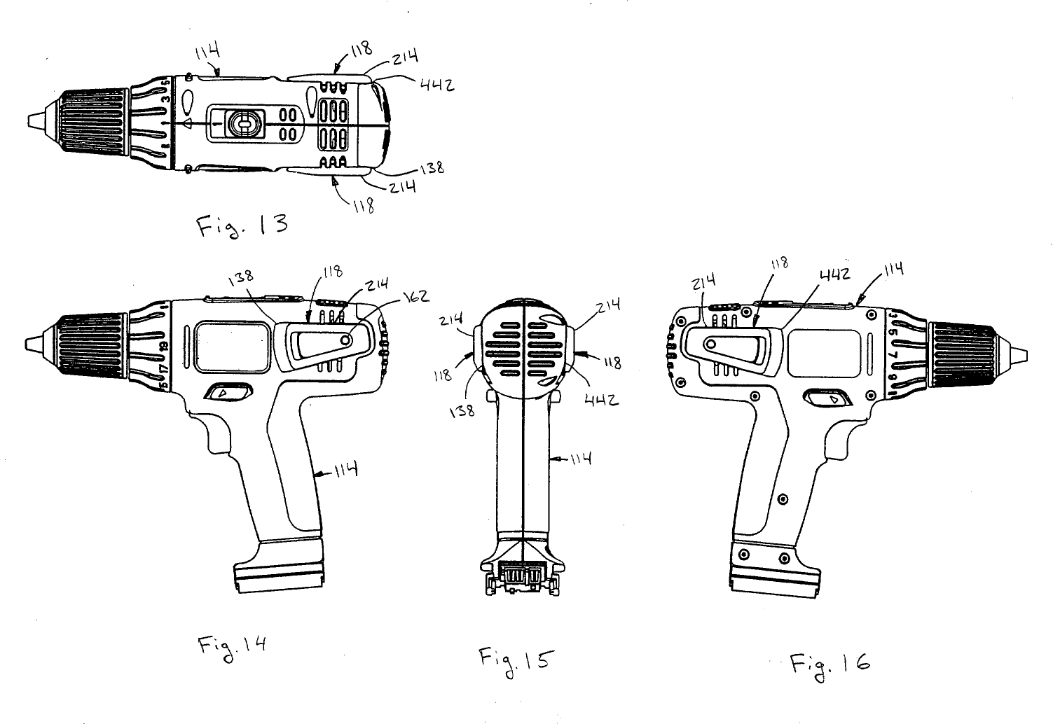

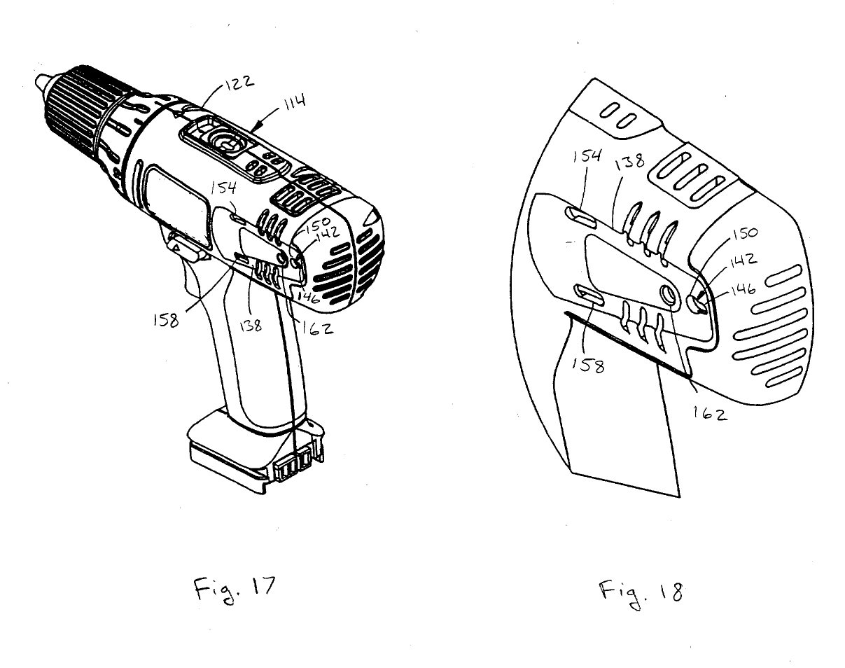

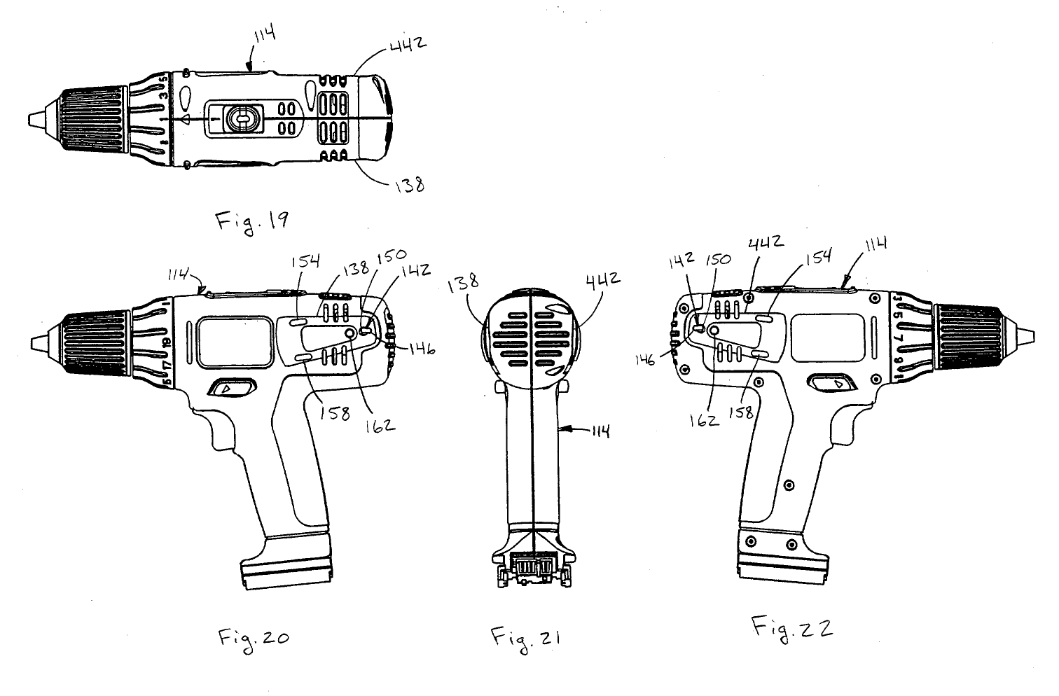

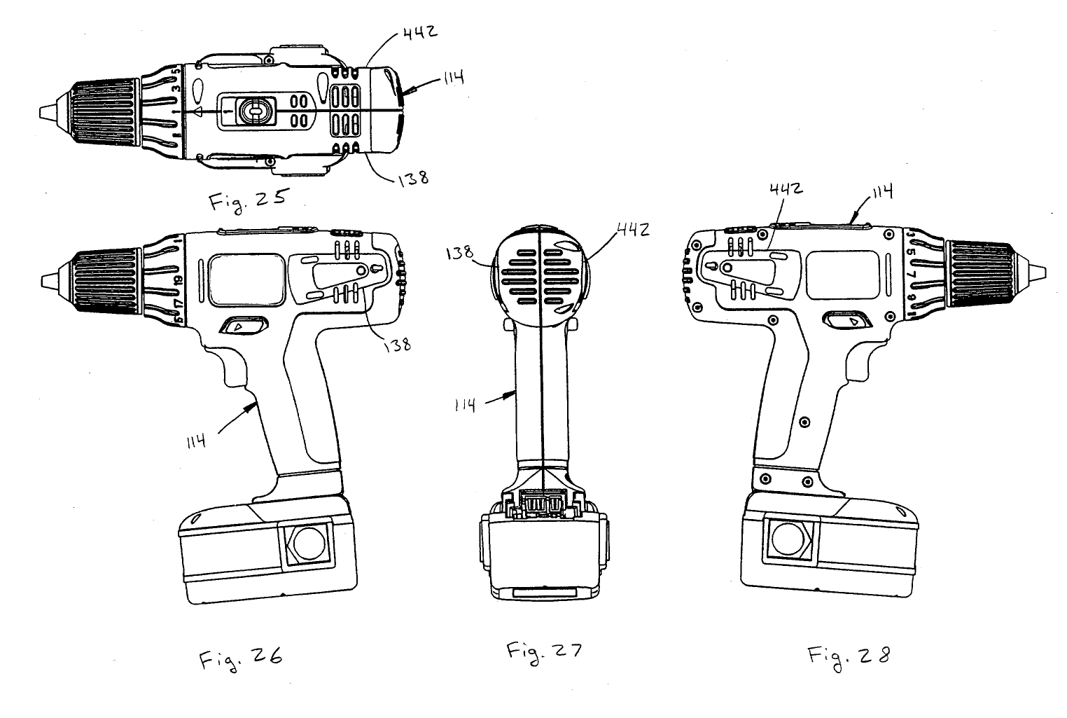

FIGS. 11-16 illustrate another construction of a connecting system 110 including a power tool 114 and a component 118 removably connected to the power tool 114. FIGS. 17-28 illustrate the power tool 114 with the component 118 (FIGS. 11-16) removed from power tool 114. In the illustrated construction, the power tool 114 includes a drill having a housing 122 and a chuck 126. The housing 122 has a forward portion 130 adjacent the chuck 126, and a rearward portion 134 opposite the forward portion 130. The housing 122 also includes a connecting portion 138 on a side of the housing 122. In FIGS. 17-28, the connecting portion 138 is relatively flat and is disposed near the rearward portion 134 of the housing 122.

The power tool 114 includes a receptacle or locking aperture 142 in the connecting portion 138 of the housing 122. The locking aperture 142 may include an elongated slot having a locking portion 146 and an unlocking portion 150. The locking aperture 142 may include a slot width. As shown in FIG. 18, the unlocking portion 150 is disposed forward of the locking portion 146, and the unlocking portion 150 has a slot width greater than the slot width of the locking portion 146.

In the illustrated construction, the power tool 114 includes a first aperture 154 and a second aperture 158 in the connecting portion 138 forward of the locking aperture 142. In FIG. 18, the first and second apertures 154, 158 are elongated, and may extend forwardly behind the surface of the housing 122. In the illustrated construction, the power tool 114 also includes a recess 162 in the connecting portion 138 extending into the housing 122. In FIG. 18, the recess 162 is disposed near the locking aperture 142.

FIGS. 33-40 illustrate a construction of the component 118. As shown in FIG. 11, the component 118 is removably connectable with the power tool 114 adjacent the connecting portion 138. As shown in FIGS. 33-40, the component is generally “U” or “V” shaped and has a generally triangular, trapezoidal, or pie shape. The component 118 includes a body having a back side 166 facing toward the power tool 114 (FIG. 11) when the component 118 is connected to the power tool 114 (FIG. 11), and an exposed side 170 opposite the back side 166 and facing away from the power tool 114 (FIG. 11) when the component 118 is connected to the power tool 114 (FIG. 11). The component 118 may include an open end 174 and a closed end 178 at opposite ends of the component 118. In the illustrated construction, the closed end 178 may be narrower than the open end 174 when viewed from a side view, as shown in FIG. 37.

In FIGS. 33-40, the component 118 includes a stud or locking member 182 projecting outwardly from the back side 166. The locking member 182 is insertable into the locking aperture 142 (FIG. 18) to engage the component 118 to the power tool 114. The locking member 182 may include a shaft 186 projecting outwardly from the component 118, an end 190 of the shaft 186 opposite the component 118, and a shaft head 194 disposed at the end 190 and having a width greater than the width of the shaft 186. In the illustrated construction, the shaft head 194 is generally circular and extends radially outwardly from the shaft 186. In other constructions, the shaft head 194 may form a T-shape or an L-shape with the shaft 186.

In the illustrated construction, the component 118 also includes a first leg 198 and a second leg 202 projecting from the back side 166. The first and second legs 198, 202 may be generally L-shaped, first projecting away from the back side 166 and then having a tab 206 extending away from the locking member 182. The first and second legs 198, 202 may be insertable into the first and second apertures 154, 158 (FIG. 18), respectively, to engage the component 118 to the power tool 114. In some constructions (not shown), the component 118 may include a single leg insertable into a single corresponding aperture in the connecting portion 138. In other constructions (not shown), the component 118 may include only a locking member 182 extending from the component 118 and engageable with the power tool 114. Alternatively, the component 118 may include a flange engageable with a slot in the power tool 114 to help align the component 118 with the connecting portion 138.

FIGS. 29-32 illustrate various stages of connecting the component 118 to the power tool 114. In FIG. 29, the component 118 is disengaged from the power tool 114. As shown in FIG. 30, the component 118 may be aligned at a slight angle relative to the connecting portion 138 as the first and second legs 198, 202 are inserted into the first and second apertures 154, 158 respectively.

As mentioned above, the locking aperture 142 includes the unlocking portion 150 having a slot width greater than the slot width of the locking portion 146. The unlocking portion 150 is larger than the shaft head 194, and permits the shaft head 194 to pass through the unlocking portion 150. The locking portion 146 is smaller than the shaft head 194, and prevents the shaft head 194 from passing through locking portion 146. The shaft 186 of the locking member 182 is narrower than the locking portion 146, and may extend through the locking portion 146 when the locking member 182 is inserted into the locking aperture 142.

As shown in FIGS. 30-31, when the tabs 206 are positioned in the apertures 154, 158, the component 118 may be pivoted relative to the connecting portion 138 and the locking member 182 may be inserted into the locking aperture 142 through the unlocking portion 150. The first and second legs 198, 202 are secured in the first and second apertures 154, 158 respectively when the locking member 182 is positioned in the locking aperture 142.

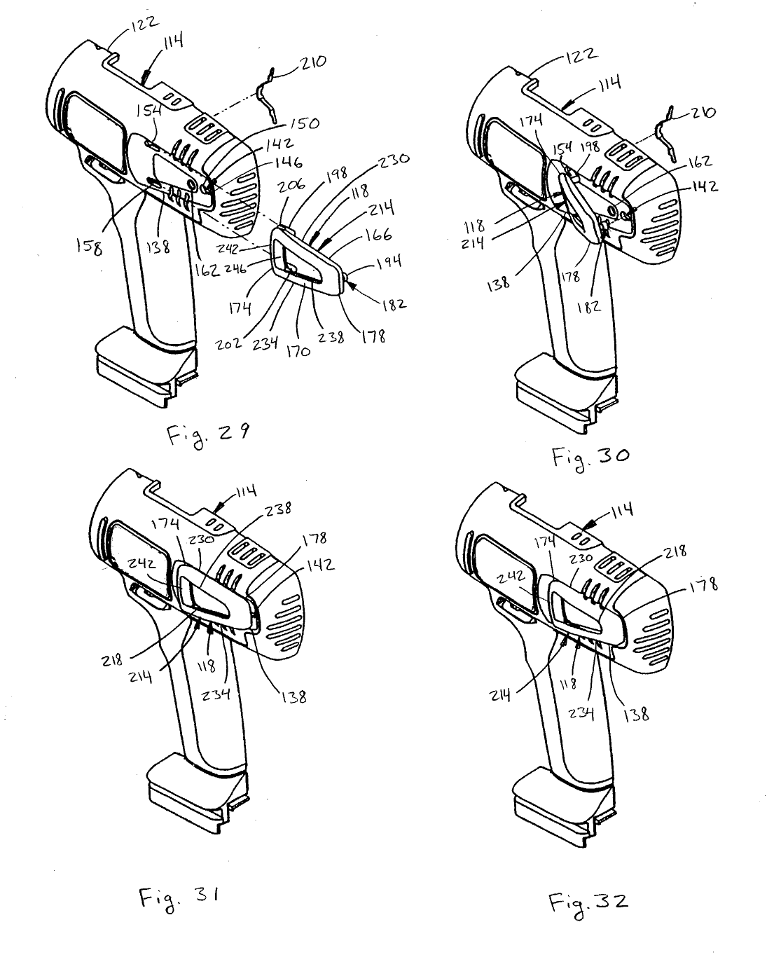

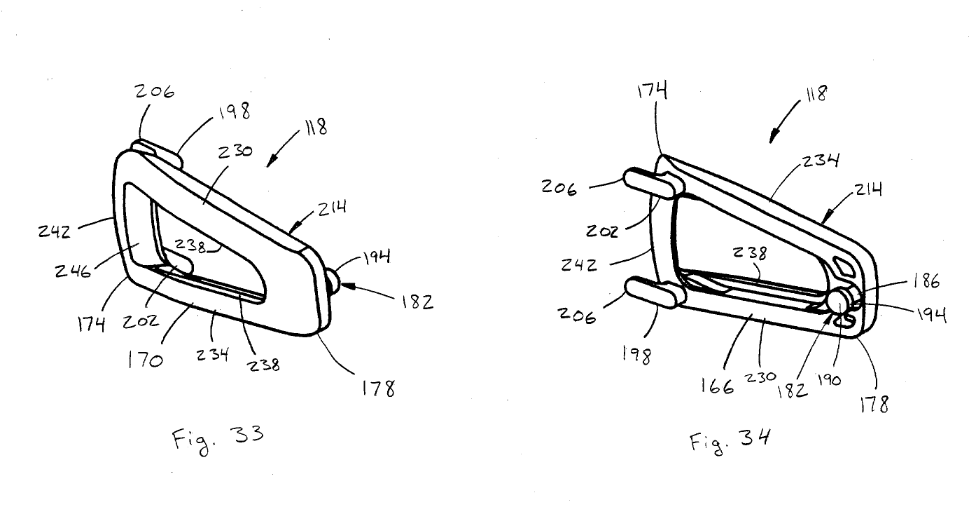

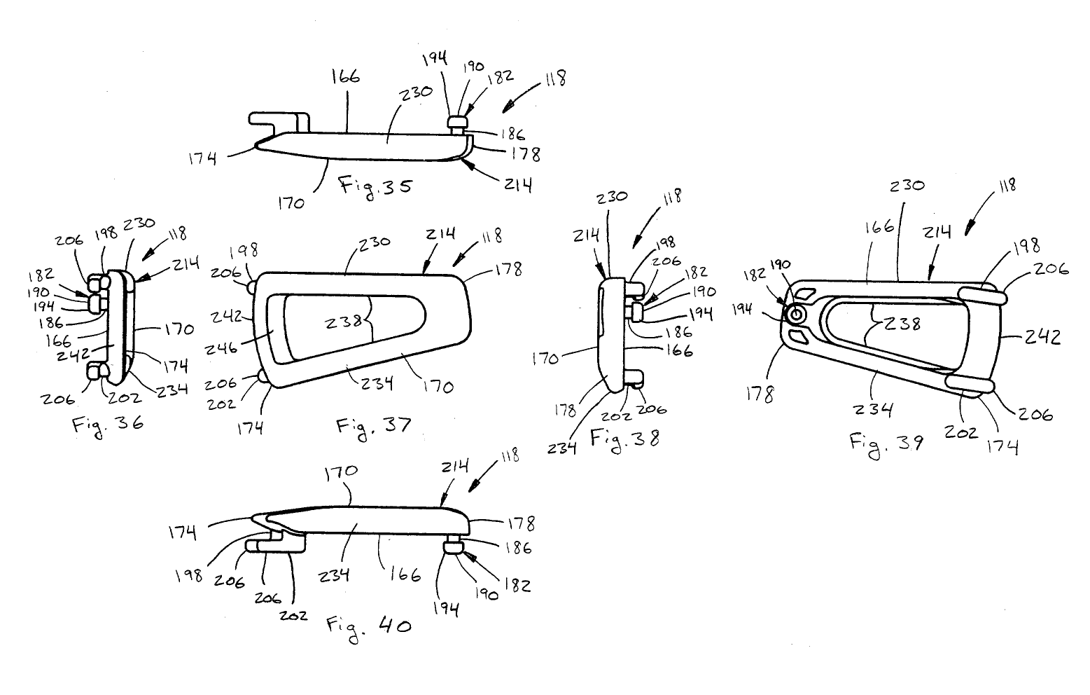

When the locking member 182 is inserted into the locking aperture 142, the component 118 is moveable between a locked position, in which the locking member 182 is secured within the locking aperture 142, and an unlocked position, in which the locking member 182 is removable from the locking aperture 142. In the illustrated construction, FIG. 31 illustrates the component 118 in the unlocked position with the locking member 182 aligned with the unlocking portion 150, and FIG. 32 illustrates the component 118 in the locked position with the locking member 182 aligned with the locking portion 146. The connecting portion 138 is a relatively flat surface, and the component 118 is movable in a direction substantially parallel to the connecting portion 138 when moving between the locked and unlocked positions.

In the illustrated construction, the first and second legs 198, 202 are also positioned within the first and second apertures 154, 158 respectively when the component 118 is movable between the locked and unlocked positions. As shown in FIGS. 29 and 30, the power tool 114 includes a biasing spring 210 connected to the power tool 114 within the housing 122. The biasing spring 210 is disposed adjacent the first and second apertures 154, 158. In the illustrated construction, the biasing spring 210 is a leaf spring, and engages the tabs 206 of the first and second legs 198, 202 when the first and second legs 198, 202 are positioned within the first and second apertures 154, 158. The biasing spring 210 biases the component 118 toward the locked position.

The component 118 may be moved against the bias to the unlocked position to disconnect the component 118 from the power tool 114. In the unlocked position, the locking member 182 may be removed from the unlocking portion of the locking aperture 142. After the locking member 182 is removed from the locking aperture 142, the first and second legs 198, 202 may be removed from first and second apertures 154, 158 respectively to disconnect the component 118 from the power tool 114.

In FIGS. 11-16 and 29-40, the component 118 includes a retainer 214. When the retainer 214 is connected to the power tool 114, the retainer 214 and the connecting portion 138 at least partially define a receptacle 218. In the illustrated construction, the retainer 214 is substantially V-shaped and includes the open end 174, the closed end 178 opposite the open end 174, and two side members 230, 234 extending between the open end 174 and the closed end 178. In the illustrated construction, the locking member 182 is disposed near the closed end 178, and the first and second legs 198, 202 extend from the open end 174. When the retainer 214 is connected to the power tool 114, the open end 174 faces toward the forward portion 130, and the closed end 178 faces toward the rearward portion 134.

As shown in FIGS. 33-40, the retainer 214 includes a ridge 238 projecting inwardly from each side member 230, 234 and extending toward the opposite side member 230, 234. The ridge 238 extends along the side members 230, 234 and the closed end 178 adjacent the exposed side 170. In the illustrated construction, the retainer 214 includes a cross member 242 extending between the side members 230, 234 near the open end 174. The cross member 242 includes a slanted entry portion 246 slanting from the exposed side 170 toward the back side 166 as the entry portion 246 progresses inwardly from the open end 174 toward the closed end 178.

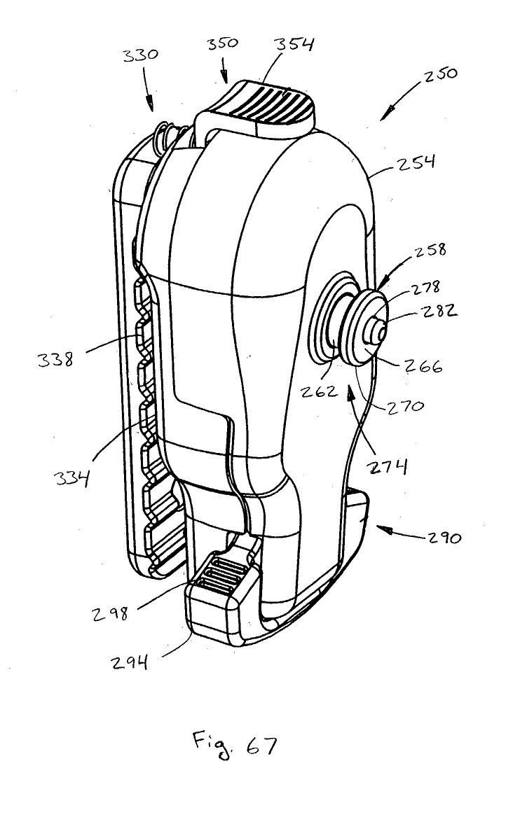

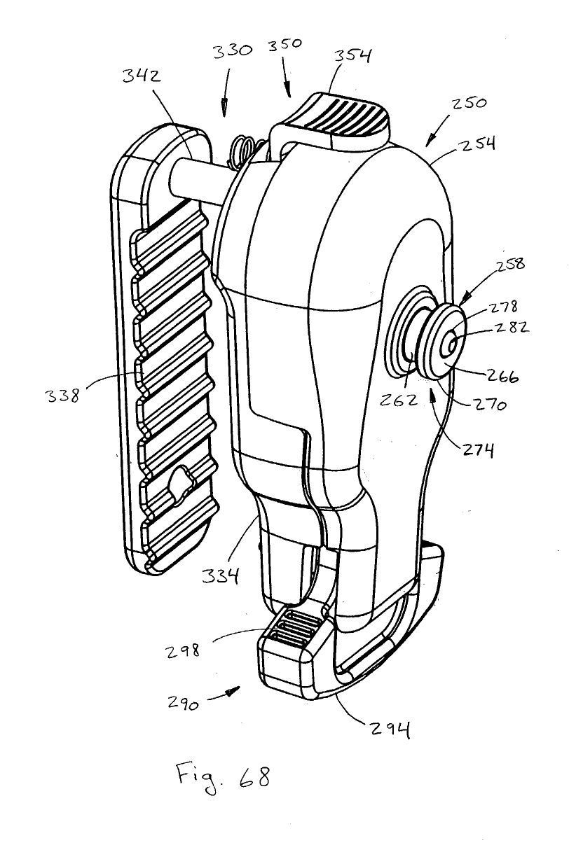

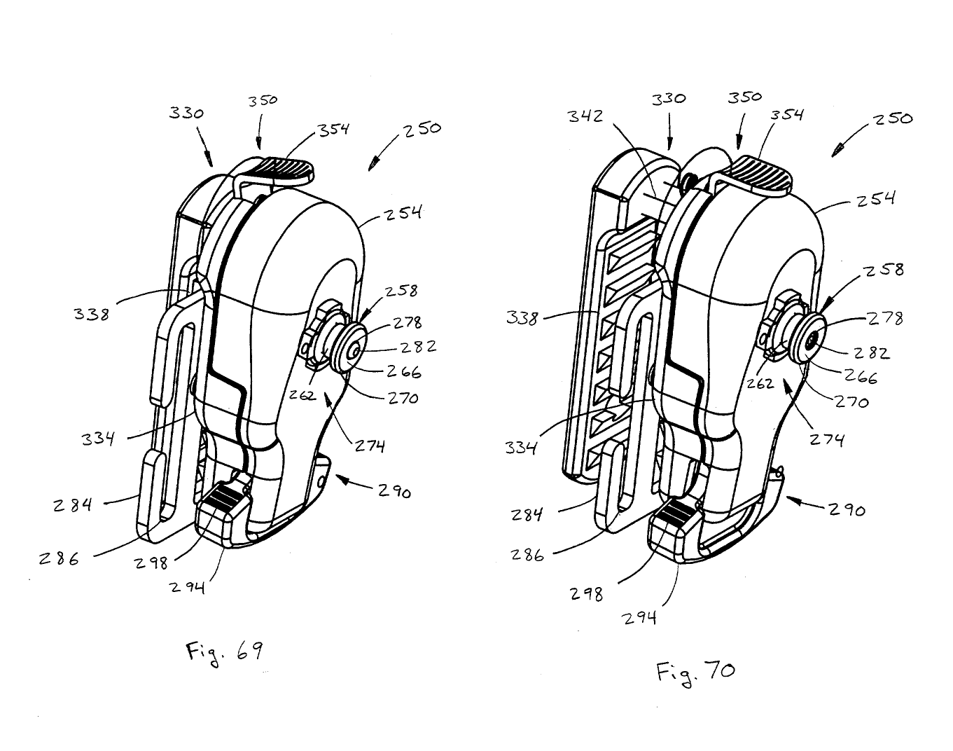

In some constructions and in some aspects, the connecting system 110 may include an attachment member 250 removably engageable with the power tool 114 and retainer 214. FIGS. 67-68 illustrate the attachment member 250 having a body 254 and a stud 258 projecting outwardly from the body 254. The stud 258 may be inserted into the receptacle 218 (FIG. 11) and engageable with the retainer 214 (FIG. 11) to removably connect the attachment member 250 and the power tool 114 (FIG. 11). The stud 258 includes a post 262 extending outwardly from the body 254 to an end 266 opposite the body 254. The stud 258 also includes a stud head 270 disposed at the end 266 and extending radially outwardly from the post 262.

The attachment member 250 may include a locking mechanism 274 selectively engageable to restrict movement of the stud 258 relative to the retainer 214. In the illustrated construction, the locking mechanism 274 includes a passage 278 extending through the stud 258 and a pin 282 at least partially disposed within the passage 278 and extending outwardly from the stud head 270. The pin 282 may be engageable with the recess 162 (FIG. 18) in the connecting portion 138 to selectively retain the stud 258 within the receptacle (FIG. 11). The pin 282 may be movable between a locked position, in which the pin 282 extends outwardly from the stud 258, and an unlocked position, in which the pin 282 is retracted back into the stud 258. In the locked position, the pin 282 may extend into the recess 162 (FIG. 18) to engage the power tool 114 (FIG. 11) and secure the stud 258 within the receptacle 218 (FIG. 11). In the unlocked position, the pin 282 is removed from the recess 162 (FIG. 18) and the stud 258 is removable from the receptacle 218 (FIG. 11). FIG. 67 illustrates the pin 282 in the locked position extending from the stud 258, and FIG. 68 illustrates the pin 282 in the unlocked position retracted into the passage 278.

In some constructions and in some aspects, the attachment member 250 may include a belt hook 284 connected to the body 254 and having two hook slots 286. In FIGS. 69-70, the belt hook 284 and the stud 258 are disposed on opposite sides of the body 254. A work belt, or other fastening strap, may be inserted through the hook slots 286 to connect the attachment member 250 to the work belt, or fastening strap. FIG. 69 illustrates the pin 282 in the locked position extending from the stud 258, and FIG. 70 illustrates the pin 282 in the unlocked position retracted into the passage 278.

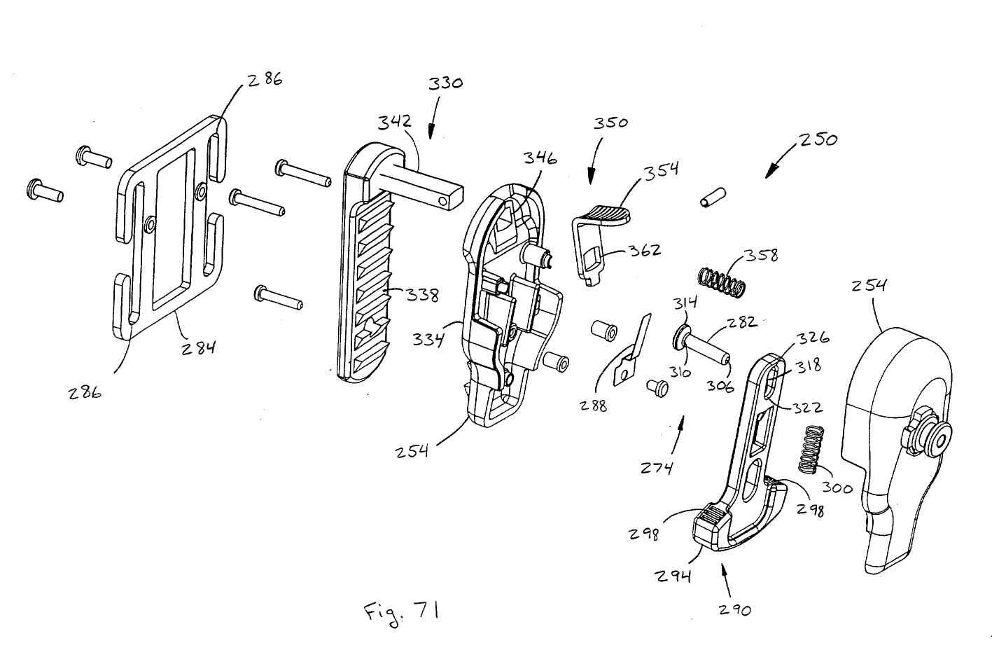

FIG. 71 illustrates an exploded assembly view of the attachment member 250. In the illustrated construction, the attachment member 250 includes a biasing spring 288 biasing the pin 282 toward the locked position. The attachment member 250 includes a release mechanism 290 that is selectively actuatable to move the pin 282 against the bias and toward the unlocked position. In the illustrated construction, the release mechanism 290 includes a lever 294 movable between a locked position and an unlocked position, which correspond to the locked position and unlocked position of the pin 282 described above. In the illustrated construction, the lever 294 generally moves away from the body 254 when moving from the locked position toward the unlocked position. FIGS. 67 and 69 illustrate the lever 294 and the pin 282 in the locked position, and FIGS. 68 and 70 illustrate the lever 294 and the pin 282 in the unlocked position.

As shown in FIG. 71, the lever 294 is generally T-shaped, and includes a trigger 298 having thumb grips extending out of the body 254. The lever 294 is movable in a linear direction between the locked and unlocked positions, and is biased toward the locked position. The attachment member 250 may include a biasing spring 300 biasing the lever 294 toward the locked position. An operator may engage the trigger 298 to move the lever 294 and pin 282 against the bias toward the respective unlocked positions. When the power tool 114 (FIG. 11) is connected to the attachment member 250 on the operator's work belt, the trigger 298 may be positioned near the operator's thumb for convenient actuation when the operator grips the handle of the power tool 114 (FIG. 11).

In the illustrated construction, the lever 294 includes a release slot 302 near the end of the lever 294 opposite the trigger 298. The release slot 302 is aligned with the passage 278 of the stud 258, and extends in a generally linear direction in substantially the same direction as the movement of the lever 294. The pin 282 extends through the release slot 302 and the passage 278, and includes a locking end 306 extending out of the stud head 270 and an actuating end 310 disposed opposite the locking end 306. The pin 282 includes a pin head 314 extending radially outwardly from the actuating end 310 of the pin 282.

In the illustrated construction, the lever 294 is disposed between the pin head 314 and the stud 258. The lever 294 includes a cam 318 adjacent the release slot 302. The cam 318 faces away from the stud 258 and engages the pin head 314 to actuate the pin 282 between the locked and unlocked positions. The cam 318 is generally slanted and includes a lock portion 322 and an unlock portion 326. The distance from the lock portion 322 to the stud 258 is less than the distance from the unlock portion 326 to the stud 258. The lock portion 322 engages the pin head 314 when the lever 294 and pin 282 are in the respective locked positions, and the unlock portion 326 engages the pin head 314 when the lever 294 and the pin 282 are in the respective unlocked positions.

In the illustrated construction, when the lever 294 is moved from the locked position toward the unlocked position, or downwardly as shown in FIG. 71, the slanted surface of the cam 318 engages the pin head 314 to draw the pin 282 away from the stud 258 and retract the locking end 306 of the pin 282 into the stud 258. When the lever 294 is released, the biasing spring 300 returns the lever 294 to the lock position, and the biasing spring 288 returns the pin 282 to the locked position and extends the locking end 306 out of the stud 258.

In other constructions and in other aspects, the lever 294 could include a pivotal or rotational member and move in a pivotal or rotational direction, instead of the linear direction as shown in FIGS. 67-71.

In the illustrated construction, the attachment member 250 includes a clip 330 connectable to a work belt. An operator may use the clip 330 to connect the attachment member 250 to a work belt, and then connect the power tool 114 and the retainer 214 to the attachment member 250 for hands-free storage of the power tool 114 on the work belt. The clip 330 is adjustable to accommodate work belts of various size and shape.

The clip 330 includes a clip surface 334 connected to the body 254 on a side opposite the stud 258. The clip surface 334 may be integrally formed with the body 258. The clip 330 also includes a clip jaw 338 movably connected to the body 254 for movement relative to the clip surface 334. An extension pin 342 extends between the clip jaw 338 and the body 254. As shown in FIG. 71, the body 254 includes a clip aperture 346 in the clip surface. In the illustrated construction, the extension pin 342 is rigidly connected to the clip jaw 338, and extends through the clip aperture 346 into the body 254.

The attachment member 250 may include a clip locking mechanism 350 that is selectively engageable with the extension pin 342 to restrict movement of the clip jaw 338 relative to the clip surface 334. In the illustrated construction, the clip locking mechanism 350 includes a clip release mechanism having a wedge or clamp 354 that is movable relative to the body 254 between a locked position and an unlocked position. In the locked position, the clamp 354 wedgingly or clampingly engages the extension pin 342 to restrict movement of the extension pin 342 relative to the body 254. In the unlocked position, the clamp is disengaged from the extension pin 342 and the extension pin 342 is movable relative to the body 254.

In the illustrated construction, the clamp 354 is pivotally connected to the body 254 and pivots between the locked and unlocked positions. The attachment member 250 includes a clamp 354 biasing spring 358 that biases the clamp 354 toward the locked position. The clamp 354 may be actuated against the bias to move the clamp 354 toward the unlocked position. As shown in FIG. 71, the clamp 354 includes a clamp aperture 362, and the extension pin 342 extends through the clamp aperture 362. As the clamp 354 pivots relative to the extension pin 342 toward the locked position, the sides of the clamp aperture 362 wedgingly or clampingly engage the extension pin 342 to restrict movement of the extension pin 342 relative to the body 254. As the clamp 354 pivots toward the unlocked position, the sides of the clamp aperture 362 disengage the extension pin 342, and the extension pin 342 may freely move through the clamp aperture 362.

In other aspects and in other constructions (not shown), the clip locking mechanism 350 may include a locking portion or a ratchet mechanism that restricts movement of the extension pin 342 relative to the body 254. The extension pin 342 may include teeth, or a rack gear, and the ratchet mechanism may engage the teeth of the extension pin 342 to restrict movement of the extension pin 342. The ratchet mechanism may be movable between a locked position, in which the ratchet mechanism engages the teeth, and an unlocked position in which the ratchet mechanism is disengaged from the teeth.

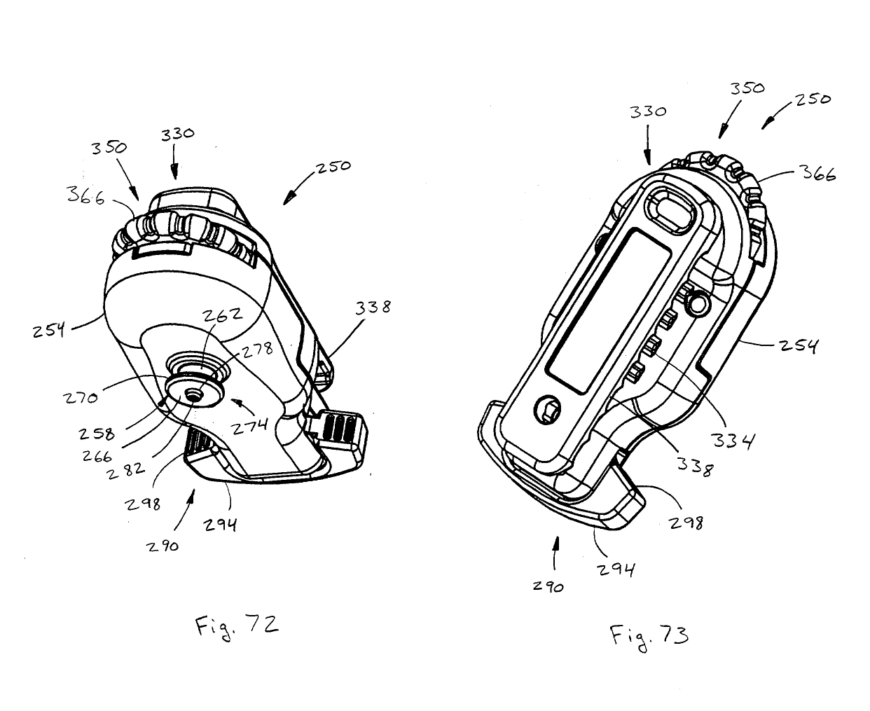

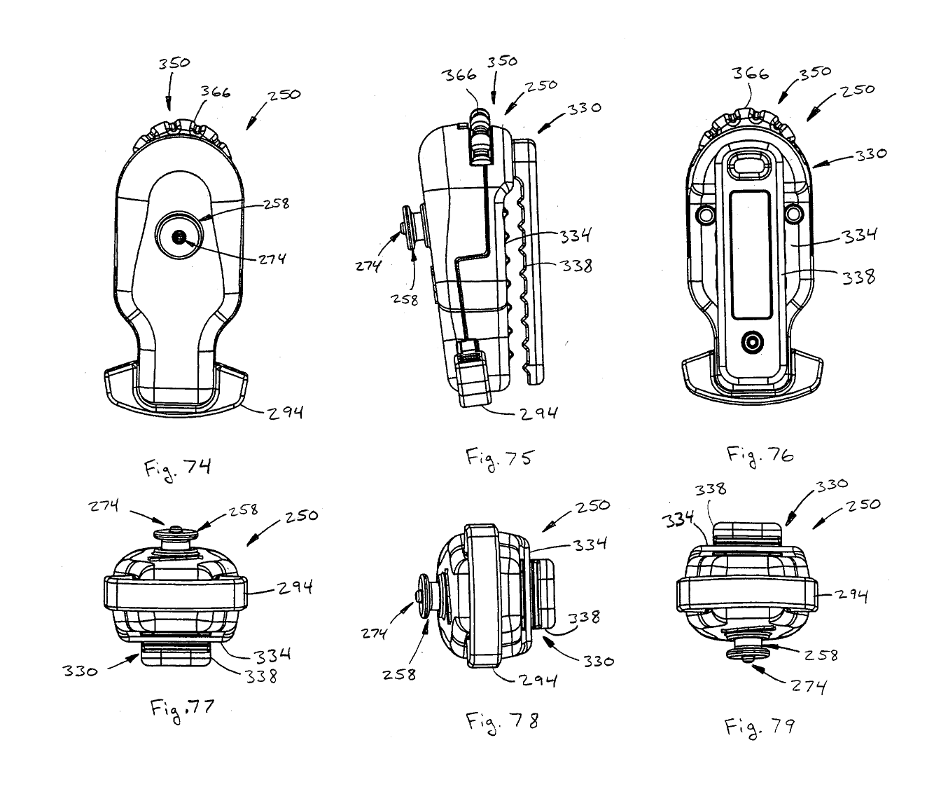

In other aspects and in other constructions, the clip locking mechanism 350 may include a dial 366 to adjust the clip 330, as shown in FIGS. 72-79. The extension pin 342 (not shown) may include external threads, similar to a bolt, and the dial 366 may include internal threads, similar to a nut. The internal threads of the dial 366 may engage the external threads of the extension pin 342 to adjust the clip 330. The extension pin 342 and clip jaw 338 may move linearly relative to the body 254 in response to rotational movement of the dial 366.

Alternatively, the extension pin 342 may include teeth, such as a rack gear, and the dial may include a threaded portion that engages the teeth of the extension pin 342 to linearly actuate the extension pin 342 in response to rotational movement of the dial. This construction of the clip locking mechanism may be similar to the adjustment mechanism commonly implemented in a crescent wrench.

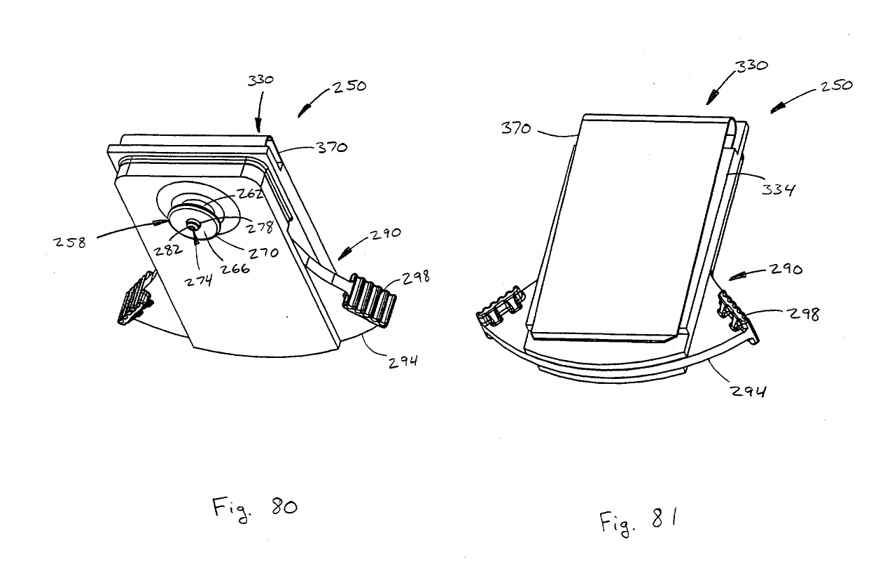

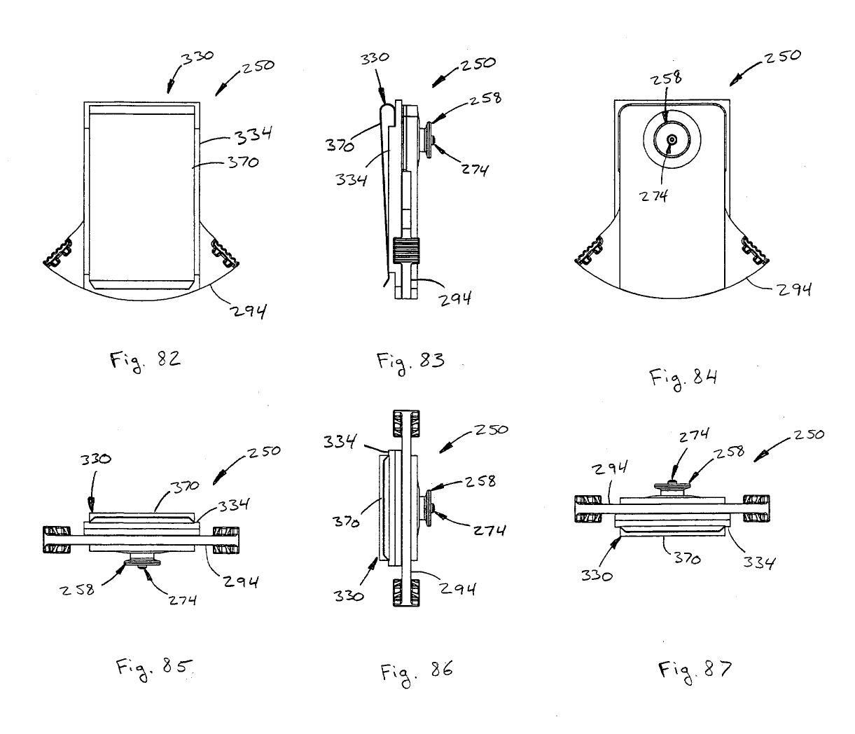

In other aspects and in other constructions, the clip 330 may include a flexible clip jaw 370 connected to the body 254, as shown in FIGS. 80-87. The flexible clip jaw 370 may be connected to the clip surface 334 of the body 254, opposite the stud 258. The flexible clip jaw 370 may engage a work belt, waist band, pocket or other similar article. As shown in FIGS. 80-87, the attachment member 250 also includes a construction of the locking mechanism 274 including the stud 258 and pin 282, and the release mechanism 294 including the lever 294. The flexible clip jaw 370 may be made from a relatively rigid, yet flexible, material, such as a metal or plastic material. Alternatively, the clip 330 may include a spring biased clip jaw pivotally connected to the body 254.

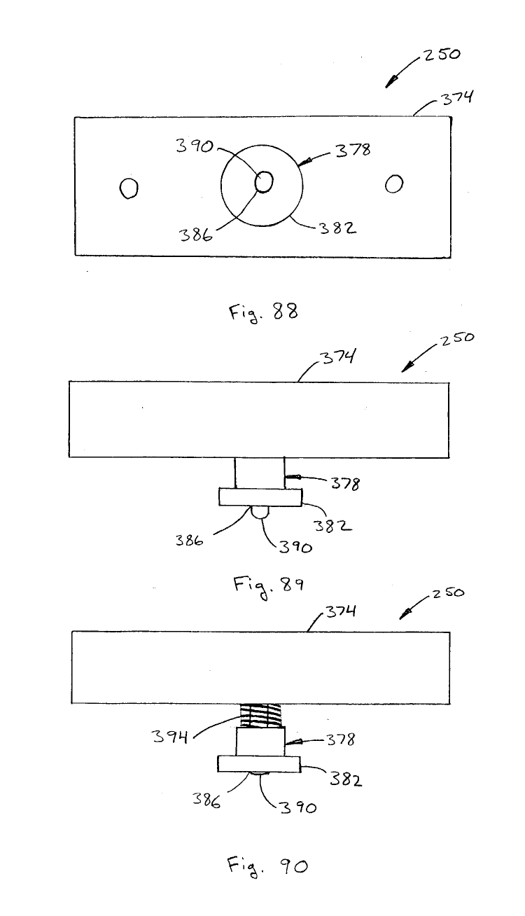

In other aspects and in other constructions, the attachment member 250 may include a mounting bracket 374, such that the attachment member 250 may be connected to an object or work area readily available for a tool operator, such as, for example, a ladder, scaffold, lift, tool chest, work bench, wall, vehicle or other similar structure or place in which the power tool 114 may be used. FIGS. 88-90 illustrate a construction of the attachment member 250 including the mounting bracket 374 and a stud 378 projecting outwardly from the mounting bracket 374. The stud 378 includes a stud head 382 disposed at an end of the stud opposite the mounting bracket 374. The stud head 382 extends radially outwardly from the stud 378. The stud 378 includes a passage 386 extending through the stud 378. A pin 390 extends through the passage 386 and projects outwardly from the stud head 382. The pin 390 is engageable with the recess 162 (FIG. 18) in the connecting portion 138 (FIG. 18) of the power tool 114 (FIG. 11) to secure the stud 378 within the receptacle 218 (FIG. 11).

In the illustrated construction, the pin 390 is fixed relative to the mounting bracket 374, and the stud 378 is movable relative to the mounting bracket 374. The stud 378 is movably connected to the mounting bracket 374, and may include a biasing spring 394 biasing the stud 378 toward the mounting bracket 374. Movement of the stud 378 away from the mounting bracket 374 may be limited. The stud 378 may be inserted into the receptacle 218 (FIG. 11) to connect the power tool 114 (FIG. 11) and retainer 214 (FIG. 11) to the attachment member 250. The pin 390 may engage the recess 162 (FIG. 18) to secure the stud 378 within the receptacle 218 (FIG. 11).

As mentioned above, the stud 378 is movable and the pin 390 is fixed relative to the mounting bracket 374. When the tool 114 (FIG. 11) is connected to the attachment member 250 and moved away from the mounting bracket 374, the ridge 238 (FIG. 11) of the retainer 214 (FIG. 11) may engage the stud head 382 and draw the stud 378 away from the mounting bracket 374. As the stud 378 moves away from the mounting bracket 374, the pin 390 may retract into the stud 378 and disengage from the recess 162 (FIG. 18). Once the pin 390 is disengaged, the stud 378 may be removed from the receptacle 218 (FIG. 11), and the tool 114 (FIG. 11) and retainer 214 (FIG. 11) may be removed from the attachment member 250. FIG. 89 illustrates the stud 378 adjacent the mounting bracket 374 with the pin 390 projecting from the stud 378. FIG. 90 illustrates the stud 378 separated from the mounting bracket 374 with the pin 390 retracted into the stud 378.

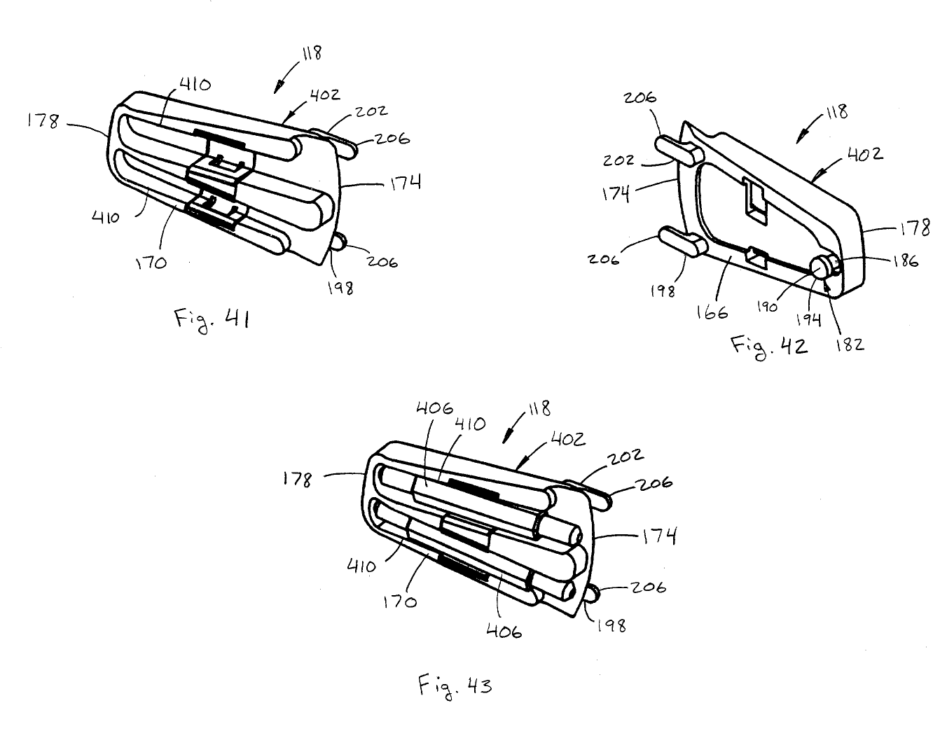

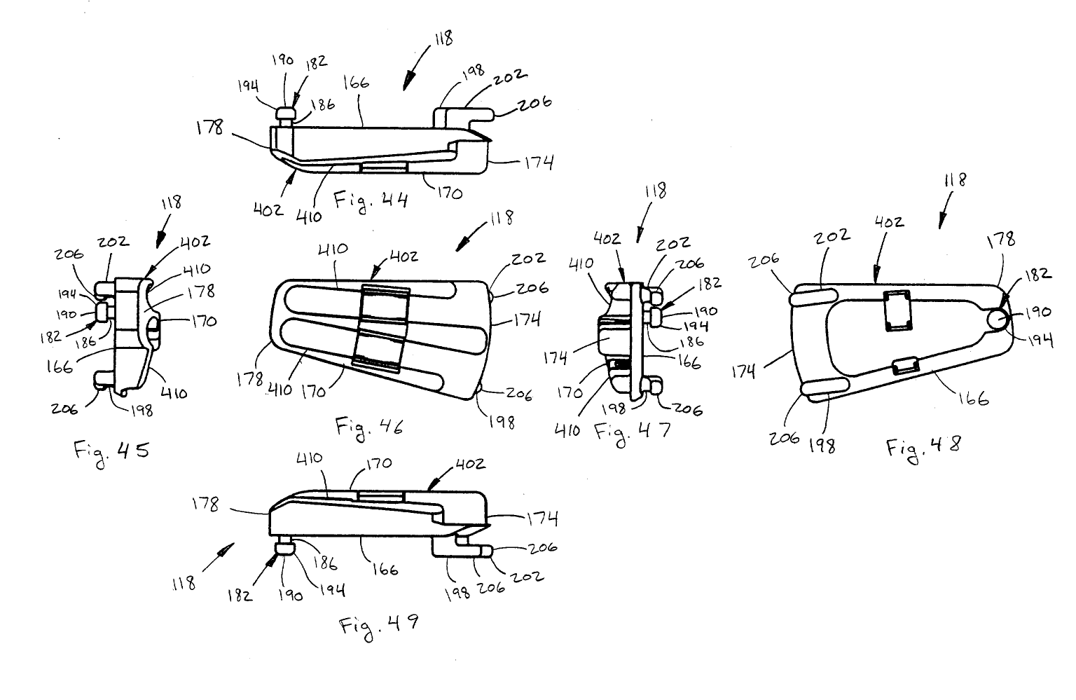

In some aspects and in some constructions, the component 118 may include accessories other than the retainer 214. As shown in FIGS. 41-49, the component 118 includes a bit holder 402 that is removably connectable with the connecting portion 138 (FIG. 18) of the power tool 114 (FIG. 11). The bit holder 402 includes many of the same elements described above in relation to the component 118. In the illustrated construction, the power tool 114 (FIG. 11) includes a drill. The bit holder 402 may retain a drill bit 406, a driver bit, or any other similar tool for the drill in a position that is easily accessible for an operator of the power tool 114. In the illustrated construction, the exposed side 170 of the bit holder 402 includes two bit slots 410 extending generally from the closed end 178 toward the open end 174. The bit slot 410 may frictionally engage the bit 406 with an interference fit, may include a magnetic member that magnetically retains a metallic bit 406, may include both means for engaging the bit 406 and retaining the bit 406 within the bit slot 410, or may include a similar retaining means. In other constructions and in other aspects (not shown), the bit holder 402 may include a single bit slot 406, or may include more than two bit slots 406.

The bit holder 402 is interchangeable with the retainer 214 (FIG. 11), and is removably connectable with the connecting portion 138 (FIG. 18) using connecting means similar to that described above in relation to the component 118 and retainer 214 (FIG. 11). As shown in FIGS. 41-49, the bit holder 402 includes the locking member 182 extending from the back side 166 of the component 118 near the closed end 178. The bit holder 402 also includes first and second legs 198, 202 projecting from the back side 166 of the component 118 near the open end 174.

As described above, the first and second legs 198, 202 are insertable into the first and second apertures 154, 158 (FIG. 18) respectively to removably engage the bit holder 402 to the power tool 114 (FIG. 11). Similarly, the locking member 182 is insertable into the locking aperture 142 (FIG. 18) to removably engage the bit holder 402 to the power tool 114 (FIG. 11). The bit holder 402 is movable between a locked position, in which the locking member 182 is secured within the locking aperture 142, and an unlocked position, in which the locking member 182 is removable from the locking aperture 142.

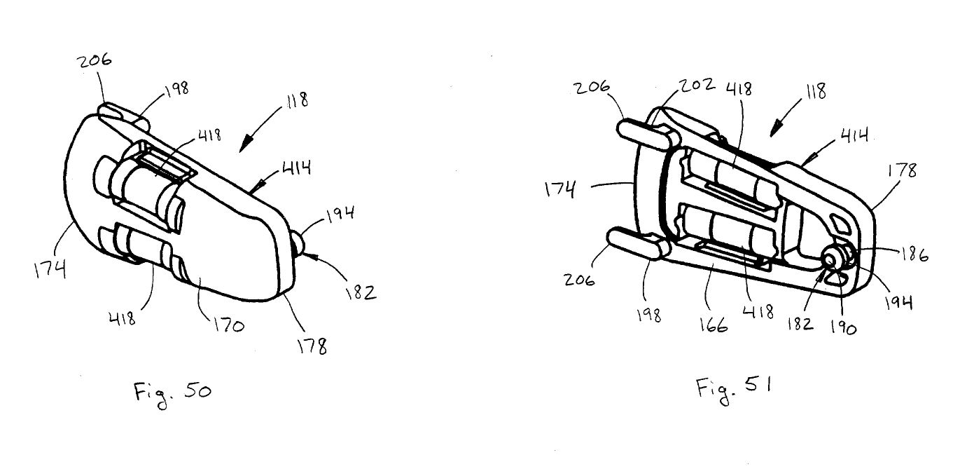

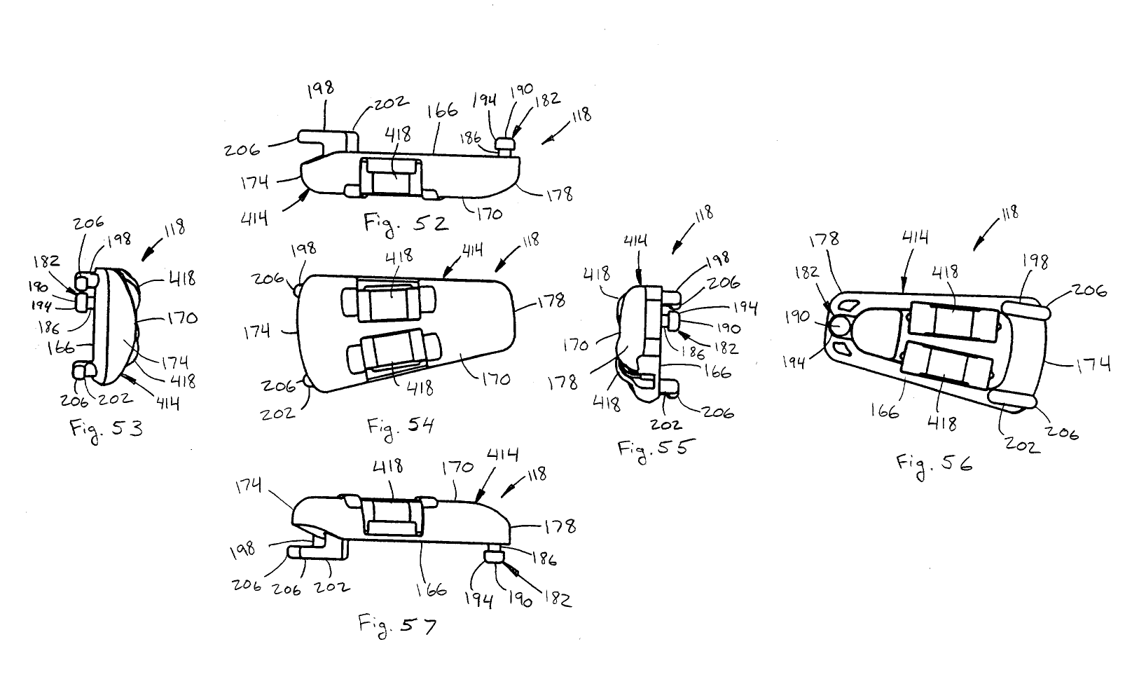

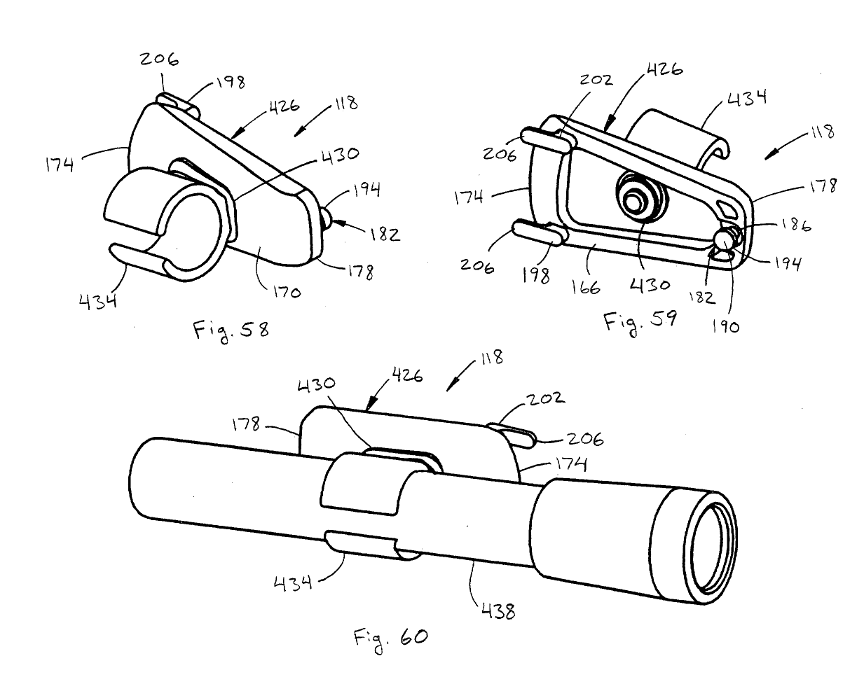

As shown in FIGS. 50-57, the component 118 includes a level 414 that is removably connectable with the connecting portion 138 (FIG. 18) of the power tool 114 (FIG. 11). The level 414 includes many of the same elements described above in relation to the component 118. In the illustrated construction, the level 414 includes two bubble tubes 418 on the exposed side 170. The bubble tubes 418 may have a gas bubble trapped within a fluid filled cylinder, similar to conventional bubble levels.

The level 414 may be connected to the side of the power tool 114 (FIG. 11) to indicate the orientation of the tool 114 (FIG. 11) relative to a true horizontal or vertical direction. In the illustrated construction, the power tool 114 is a drill, and the chuck 126 rotates about a drill axis 422 (FIG. 11). The level 414 may be configured to align the drill axis 422 with a true horizontal or vertical direction when the level 414 is connected to the power tool 114 (FIG. 11).

In the illustrated construction, the bubble tubes 418 extend in a direction from the closed end 178 toward the open end 174. In this construction, the level 414 may indicate when the drill axis 422 (FIG. 11) is aligned horizontally. In other constructions, the bubble tubes 418 may be rotated 90 degrees and may indicate when the drill axis 422 (FIG. 11) is aligned vertically. In yet other constructions, the level 414 may include two bubble tubes 418 positioned 90 degrees from one another to indicate both horizontal and vertical orientation.

The level 414 is interchangeable with the retainer 214, and is removably connectable with the connecting portion 138 (FIG. 18) using connecting means similar to that described above in relation to the component 118 and retainer 214 (FIG. 11). As shown in FIGS. 50-57, the level 414 includes the locking member 182 and first and second legs 198, 202 projecting from the back side 166 of the component 118. As described above, the first and second legs 198, 202 are insertable into the first and second apertures 154, 158 (FIG. 18) respectively, and the locking member 182 is insertable into the locking aperture 142 (FIG. 18) to removably engage the level 414 to the power tool 114 (FIG. 11). The level 414 is movable between a locked position, in which the locking member 182 is secured within the locking aperture 142 (FIG. 18), and an unlocked position, in which the locking member 182 is removable from the locking aperture 142 (FIG. 18).

In the illustrated construction, the locking member 182 and first and second legs 198, 202 may extend an equal distance from the level 414, relative to the bubble tubes 418. Therefore, the level 414 may indicate the orientation of a flat surface when the level 414 is placed upon the surface. The first and second legs 198, 202 and locking member 182 may support the bubble tubes 418 a uniform distance from the surface to determine if the surface is aligned horizontally. Alternatively, the position of the bubble tubes 418 may be altered to determine other orientations.

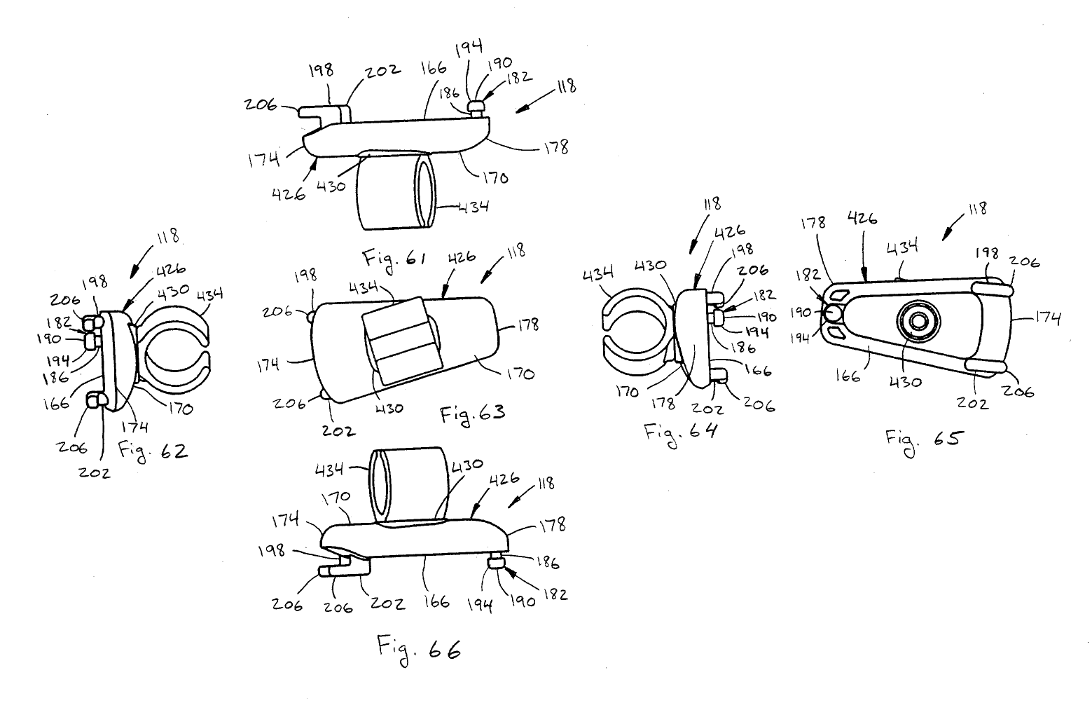

As shown in FIGS. 58-66, the component 118 includes a light 426 that is removably connectable with the connecting portion 138 (FIG. 18) of the power tool 114 (FIG. 18). The light 426 includes many of the same elements described above in relation to the component 118. In the illustrated construction, the light 426 includes a base 430 and a light holder 434 pivotally mounted to the base 430 on the exposed side 170. The light holder 434 may retain a removable light source 438, such as a flashlight, as shown in FIG. 60. The pivotal light holder 434 may be adjusted to illuminate a desired work area. The light holder 434 may also provide storage of the light source 438 when not in use.

The light 426 is interchangeable with the retainer 214 (FIG. 11), and is removably connectable with the connecting portion 138 (FIG. 18) using connecting means similar to that described above in relation to the component 118 and retainer 214 (FIG. 11). As shown in FIGS. 58-66, the light 426 includes a locking member 182 and first and second legs 198, 202 projecting from the back side 166 of the component 118. As described above, the first and second legs 198, 202 are insertable into the first and second apertures 154, 158 (FIG. 18) respectively, and the locking member 182 is insertable into the locking aperture 142 (FIG. 18) to removably engage the level 414 to the power tool 114 (FIG. 11). The light 426 is movable between a locked position, in which the locking member 182 is secured within the locking aperture 142 (FIG. 18), and an unlocked position, in which the locking member 182 is removable from the locking aperture 142 (FIG. 18).

As shown in FIGS. 11-28, the power tool 114 may include a second connecting portion 442 on a side of the power tool 114 opposite from the first connecting portion 138. The second connecting portion 442 is substantially the same as the first connecting portion 138, and may also include the locking aperture 142, first and second apertures 154, 158, and recess 162. The component 118 is interchangeable between each connecting portion 138, 442. In some aspects and in some constructions, the connecting system 110 may include components 118 connected to both the first connecting portion 138 and the second connecting portion, as shown in FIGS. 11-16. The connecting system 110 may also include the retainer 214 connected to the first connecting portion 138 and the bit holder 402 connected to the second connecting portion 442. Any combination of one or multiple components 118, such as the retainer 214, bit holder 402, level 414, light 426, or other component 118, may be connected to any of the connecting portions 138, 442. In some aspects and in some constructions, the power tool 114 may include additional connecting portions, such as a third connecting portion on the top of the power tool 114 or other portions of the housing 122.

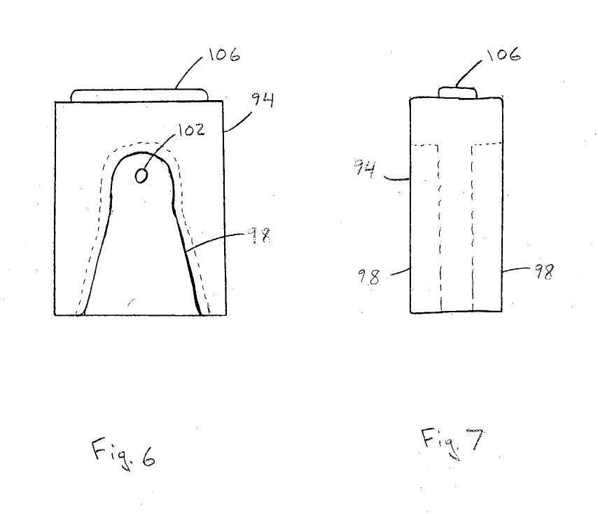

FIGS. 8 and 9 illustrate another construction of a connecting system 110 including a power tool 504 and a component 508 removably connected to the power tool 504. The power tool 504 includes a connecting portion 512 having a locking aperture 516, a first leg aperture 520, and a second leg aperture 524. The locking aperture 516 may be provided within a boss on the connecting portion 512. FIG. 8 illustrates the power tool 504 and the connecting portion 512 with the component 508 removed. FIG. 9 illustrates the power tool 504 with the component 508 connected to the connecting portion 512 of the power tool 504.

In the illustrated construction, the component 508 comprises a retainer defining a receptacle 526 with the connecting portion 512. The component 508 includes a first leg 528 insertable into the first leg aperture 520 and a second leg 532 insertable into the second leg aperture 524. In some constructions, the component 508 may include a single leg, and the connecting portion 512 may include a single leg aperture.

In FIG. 9, the component 508 includes a fastener 536 insertable into the locking aperture 516 to connect the component 508 to the power tool 504. The component 508 includes a fastener aperture aligned with the locking aperture 516, and the fastener 536 extends through the fastener aperture and into the locking aperture 516 to secure the component 508 relative to the connecting portion 512. In the illustrated construction, the fastener 536 comprises a screw or bolt that may be threaded into the locking aperture 516. In some constructions, a metal insert may be positioned within the locking aperture 516 to engage the fastener 536. The metal insert may include threads engageable with threads on the fastener 536. The fastener 536 may be removed from the locking aperture 516 to disconnect the component 508 from the power tool 504.

In the illustrated construction, the connecting portion 512 includes a recess 540 extending into the power tool 504. The component 508 and power tool 504 having the recess 540 are connectable to an attachment member 250, which is described above and shown in FIGS. 67-90. The attachment member 250 includes a stud 258 that is insertable into the receptacle at least partially defined by the component 508. The pin 282 extends from the stud 258 and may engage the recess 540 to secure the stud 258 within the receptacle 526. The attachment member 250 may include a release mechanism to selectively release the pin 282 from the recess 540.

In another construction, the power tool 504 may include a cam disposed on the connecting portion 512 instead of the recess 540. The cam may be similar to the cam 66, which is described above and shown in FIGS. 2-3. The component 508 and power tool 504 having the cam are connectable to a belt clip 18 including a stud 26 having a recess 62, which is described above and shown in FIG. 1. The stud 26 is insertable into the receptacle at least partially defined by the component 508. The cam extends from the power tool 504 and may engage the recess 62 to secure the stud within the receptacle. The power tool 504 may include a release mechanism to selectively release the cam from the recess 62.

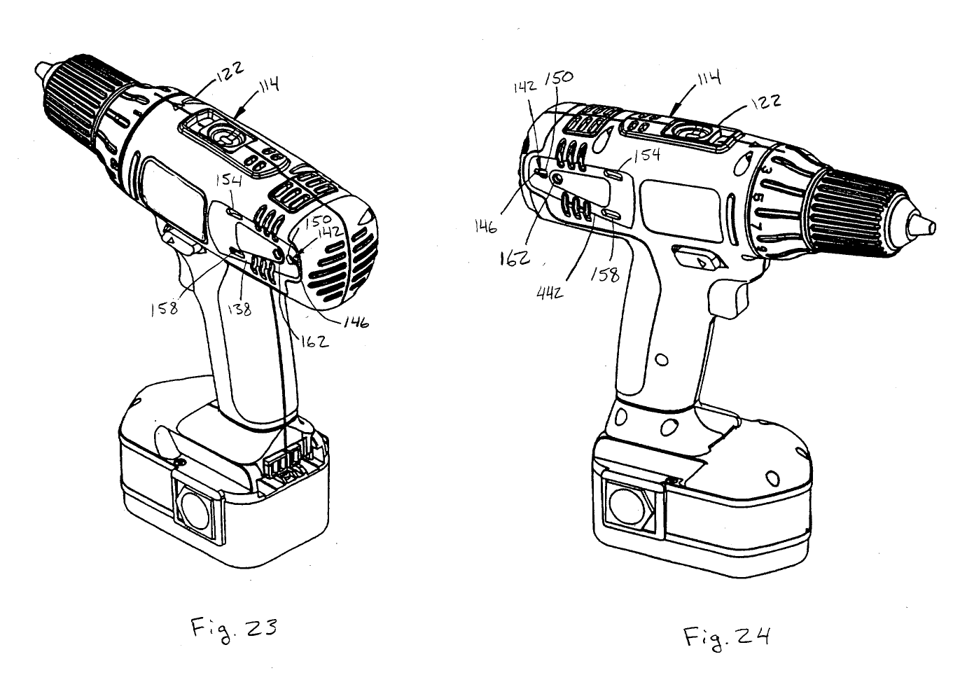

As shown in FIGS. 2-3, 9-10 and 11-32, the power tool 14, 114, 504 includes a cordless drill having a rechargeable battery. FIGS. 11-22 and 29-32 illustrate the power tool 114 without the battery, and FIGS. 23-28 illustrate the power tool 114 with the battery. Alternatively, the power tool 14, 114, 504 may include a drill having a cord.

In other aspects and in other constructions, the power tool 14, 114, 504 may include other tools, for example, a reciprocating saw, other saw, hammer drill, sander, router, impact wrench, light, or other similar power tool and power tool accessories. FIG. 10 illustrates a construction of the connecting system 110 having a power tool 550 including a cordless work light have a rechargeable battery. The connecting system 110 also includes a component 554 removably connectable with the power tool 550. In the illustrated construction, the component 554 includes a retainer at least partially defining a receptacle 558.

As shown in FIG. 10, the component 554 is substantially similar to the component 508 described above and shown in FIG. 9. In other constructions and in other aspects, the power tool 550 may include a receptacle integrally formed with the power tool 550, as described above and shown in FIGS. 2-3. In other constructions and in other aspects, the component 554 may be substantially similar to the component 118 described above and shown in FIGS. 11-16, 29-40. The power tool 550 may also be connectable to other components or accessories, such as the components 118 described above and shown in FIGS. 43-66.

The power tool 550 and component 554 shown in FIG. 10 may be connectable to a belt clip 18 (FIG. 1) or attachment member 250 (FIG. 67). The power tool 550 may include a locking mechanism to secure the power tool 550 and component 554 to the belt clip 18 (FIG. 1) or attachment member 250 (FIG. 67). The power tool 550 may include a recess, similar to the recess 540 described above and shown in FIGS. 8-9, and may be removably connectable to the attachment member 250 having the pin 282 extending from the stud 258, which is described above and shown in FIGS. 67-90. In other constructions and in other aspects, the power tool 550 may include a cam, similar to the cam 66 describe above and shown in FIGS. 2-3, and may be removably connectable to a belt clip 18 including a stud 26 having a recess 62, which is described above and shown in FIG. 1.

The illustrated connecting systems 10, 110 may be used with equipment other than the illustrated power tool 14, 114, 504 and work light 550. For example, the connecting system may be incorporated into a radio (not shown), a battery charger (not shown), a vacuum cleaner (not shown), etc. so that such equipment may be supported by the belt clip 18, by the attachment member 250, by mounting bracket 374, by other such equipment, etc. Also, the connecting system may be incorporated into other power tool accessories, such as, for example, a power tool battery, a blade holder, a tool box, a storage container, etc., so that such accessories may be supported by the belt clip 18, by the attachment member 250, by the mounting bracket 374, by other such equipment, etc.

The foregoing detailed description describes only a few of the many forms that the present invention can take and should, therefore, be taken as illustrative rather than limiting. It is only the claims, including all equivalents that are intended to define the scope of the invention.

We claim:

1. A connecting system comprising:
a power tool; and
a component removably engageable with the power tool, one of the power tool and the component defining a receptacle, the other of the power tool and the component including a stud, the stud being engageable with the receptacle to removably connect the power tool and the component.

2. The connecting system of claim 1, wherein the receptacle is substantially U-shaped and includes an open end, a closed end opposite the open end, a ridge extending at least partially around the receptacle, and an undercut portion behind the ridge, the undercut portion being exposed near the open end.

3. The connecting system of claim 2, wherein the stud includes a base, a post extending axially from the base, an end disposed opposite the base, and a head disposed at the end and extending radially outwardly from the post, the head being received in the undercut portion to connect the power tool and the component.

4. The connecting system of claim 4, wherein the stud includes an end having a recess, and wherein the connecting system further comprises a locking mechanism selectively engageable with the stud to restrict movement of the stud relative to the receptacle, the locking mechanism including a cam at least partially disposed within the receptacle and selectively engageable with the recess to retain the stud within the receptacle, the cam being movable between a locked position, in which the cam extends into the recess, and a released position, in which the cam is retracted from the recess and the stud is removable from the receptacle, the cam being biased toward the locked position, the locking mechanism also including a release mechanism actuatable to move the cam toward the released position.

5. The connecting system of claim 1, wherein the power tool defines the receptacle, and wherein the component includes the stud.

6. The connecting system of claim 5, wherein the power tool includes a housing, and wherein the receptacle is integrally formed with the housing.

7. The connecting system of claim 6, wherein the housing has a first side and a second side and defines a first receptacle on the first side and a second receptacle on the second side, the stud being selectively and alternatively engageable in the first receptacle and the second receptacle.

8. The connection system of claim 5, wherein the power tool includes a housing, the housing including a first housing portion and a removable housing portion, and wherein the receptacle is integrally formed with the removable housing portion.

9. The connecting system of claim 8, wherein the first housing portion includes a housing surface and defines an aperture, wherein the removable housing portion includes a locking member projecting from the removable housing portion and insertable into the aperture, the movable housing portion being movable in a direction substantially parallel to the housing surface between a locked position, in which the locking member is secured within the aperture, and an unlocked position, in which the locking member is removable from the aperture.

10. The connecting system of claim 8, wherein the first housing portion defines a leg aperture and a threaded aperture, wherein the removable housing portion includes a leg projecting from the removable housing portion and insertable into the leg aperture and a fastener threadable into the threaded aperture to fix the removable housing portion to the first housing portion.

11. The connecting system of claim 5, wherein the power tool includes a cap connectable to a portion of the power tool, and wherein the receptacle is defined by the cap.

12. The connecting system of claim 11, wherein the cap is at least partially elastic and is configured to fit over a portion of the power tool.

13. The connecting system of claim 1, wherein the power tool is a drill.

14. The connecting system of claim 1, wherein the component includes a belt clip, the belt clip being connectable to a work belt.

15. The connecting system of claim 1, wherein the component includes a power tool accessory.

16. The connecting system of claim 15, wherein the power tool accessory includes a light.

17. The connecting system of claim 15, wherein the power tool accessory includes a bit holder.

18. The connecting system of claim 1, wherein the power tool includes a housing having a housing surface and defining the receptacle, wherein the component includes the stud, the stud projecting from the component and being insertable into the receptacle, the component being movable in a direction substantially parallel to the housing surface between a locked position, in which the stud is secured within the receptacle, and an unlocked position, in which the stud is removable from the receptacle.

19. The connecting system of claim 1, wherein the power tool includes a housing defining a leg aperture and the receptacle, the receptacle being a threaded aperture, wherein the component includes a leg projecting from the component and insertable into the leg aperture and the stud, the stud being a fastener threadable into the receptacle to fix the component to the power tool.

20. A connecting system comprising:
a power tool including a connecting portion and defining a locking aperture;
a component removably connectable with the power tool adjacent the connecting portion, the component including a locking member extending from the component and insertable into the locking aperture, the component being movable in a direction substantially parallel to the connecting portion between a locked position, in which the locking member is secured in the locking aperture, and an unlocked position, in which the locking member is removable from the locking aperture; and
a spring engageable between the power tool and the component to bias the component toward the locked position.

21. The connecting system of claim 20, wherein the connecting portion includes a leg aperture, and wherein the component includes a leg projecting from the component and insertable into the leg aperture.

22. The connecting system of claim 21, wherein the connecting portion includes a second leg aperture, and wherein the component includes a second leg projecting from the component and insertable into the second leg aperture.

23. The connecting system of claim 21, wherein the spring is supported on the connecting portion and is engageable with the leg to bias the component toward the locked position.

24. The connecting system of claim 20, wherein the locking aperture includes a slot having a locking portion and an unlocking portion, wherein, when the component is in the unlocked position, the locking member is in the unlocking portion of the locking aperture, and wherein, when the component is in the locked position, the locking member is in the locking portion of the locking aperture.

25. The connecting system of claim 24, wherein the locking aperture has a slot width, the slot width of the unlocking portion being greater than the slot width of the locking portion, and wherein the locking member includes a shaft extending from the component, and a shaft head disposed at an end of the shaft opposite the component and wider than the shaft, the shaft head having a head width greater than the slot width of the locking portion, the shaft head being unable to pass through the locking portion of the slot.

26. The connecting system of claim 20, wherein the component includes a bit holder.

27. The connecting system of claim 20, wherein the component includes a bubble level.

28. The connecting system of claim 20, wherein the component includes a light.

29. The connecting system of claim 20, wherein the component includes a retainer defining a receptacle, and wherein the connecting system further comprises an attachment member including a stud, the stud being receivable in the receptacle to connect the power tool and the attachment member.

30. The connecting system of claim 29, wherein the attachment member includes a clip connectable to a support to support the power tool on the support.

31. The connecting system of claim 30, wherein the attachment member is a belt clip, and wherein the support is a work belt.

32. The connecting system of claim 20, wherein the power tool includes a second connecting portion disposed on a side of power tool opposite from the first-mentioned connecting portion, the second connecting portion defining a second locking aperture, and wherein the connecting system further comprises:
a second component removably connectable with the power tool adjacent the second connecting portion, the second component including a second locking member extending from the second component and insertable into the second locking aperture, the second component being movable in a direction substantially parallel to the second connecting portion between a locked position, in which the second locking member is secured in the second locking aperture, and an unlocked position, in which the second locking member is removable from the second locking aperture; and
a second spring engageable between the power tool and the second component to bias the second component toward the locked position.

33. A connecting system comprising:
a power tool including a connecting portion and defining a leg aperture and a fastener aperture; and
a component removably connectable with the power tool adjacent the connecting portion, the component including a leg extending from the component and insertable into the leg aperture and a fastener receivable into the fastener aperture, the fastener being pivotable relative to the fastener aperture between a locked position, in which the component is connected to the power tool, and an unlocked position, in which the component is removable from the power tool.

34. The connecting system of claim 33, wherein the fastener aperture is a threaded aperture, and wherein the fastener is a threaded fastener threadedly receivable in the threaded aperture, the threaded fastener being rotatable relative to the threaded aperture between the locked position and the unlocked position.

35. The connecting system of claim 33, wherein the connecting portion includes a second leg aperture, and wherein the component includes a second leg projecting from the component and insertable into the second leg aperture.

36. The connecting system of claim 33, wherein the component includes a retainer at least partially defining a receptacle, and wherein the connecting system further comprises a second component including a stud, the second component being connectable to the power tool by engagement of the stud in the receptacle.

37. The connecting system of claim 36, wherein the second component is an attachment member removably engageable with the power tool, the attachment member including the stud, the stud being insertable into the receptacle and engageable with the retainer to removably connect the power tool and the attachment member.

38. The connecting system of claim 37, wherein the retainer includes a wall defining an undercut, and wherein the attachment member includes a body, the stud including a post extending from the body, and a stud head disposed at an end of the post opposite the body and extending radially outwardly from the post, the stud head being receivable in the undercut to limit movement of the stud relative to the receptacle in the direction of the post.

39. The connecting system of claim 38, wherein the attachment member includes a locking mechanism selectively engageable to restrict movement of the stud relative to the retainer in a direction perpendicular to the post.

40. The connecting system of claim 37, wherein the attachment member includes a clip connectable to a support to support the power tool on the support.

41. The connecting system of claim 40, wherein the attachment member is a belt clip, and wherein the support is a work belt.

42. The connecting system of claim 37, wherein the attachment member includes a body and a mounting bracket connected to the body and connectable to a support to support the power tool on the support.

43. The connecting system of claim 32, wherein the power tool includes a second connecting portion disposed on a side of power tool opposite from the first-mentioned connecting portion, the second connecting portion defining a second leg aperture and a second fastener aperture, and wherein the connecting system further comprises a second component removably connectable with the power tool adjacent the second connecting portion, the second component including a second leg extending from the second component and insertable into the second leg aperture and a second fastener receivable into the second fastener aperture, the second fastener being pivotable relative to the second fastener aperture between a locked position, in which the second component is connected to the power tool, and an unlocked position, in which the second component is removable from the power tool.

44. A connecting system comprising:
a power tool including a connecting portion and defining a leg aperture and a fastener aperture;
a retainer removably connectable with the power tool adjacent the connecting portion and at least partially defining a receptacle, the retainer including a leg extending from the retainer and insertable into the leg aperture and a fastener receivable into the fastener aperture, the fastener being pivotable relative to the fastener aperture between a locked position, in which the retainer is connected to the power tool, and an unlocked position, in which the retainer is removable from the power tool; and
an attachment member removably engageable with the power tool, the attachment member including a stud projecting from the attachment member, the stud being insertable into the receptacle and to removably connect the power tool and the attachment member.

45. The connecting system of claim 44, wherein the fastener aperture is a threaded aperture, and wherein the fastener is a threaded fastener threadedly receivable in the threaded aperture, the threaded fastener being rotatable relative to the threaded aperture between the locked position and the unlocked position.

46. The connecting system of claim 44, wherein the connecting portion includes a second leg aperture, and wherein the component includes a second leg projecting from the component and insertable into the second leg aperture.

47. The connecting system of claim 44, wherein the retainer has an open end and a closed end opposite the open end and includes
two side members extending from the closed end to the open end, and
a ridge projecting inwardly from each side member toward an opposite side member and extending along the side member toward the closed end.

48. The connecting system of claim 47, wherein the retainer includes a cross member extending between the side members near the open end, the cross member having an entry portion slanting into the receptacle from the open end toward the closed end.

49. The connecting system of claim 47, wherein the attachment member includes a body, the stud including a post extending from the body, and a stud head disposed at an end of the post opposite the body and extending radially from the post the stud head being receivable under the ridge to limit movement of the stud relative to the receptacle in the direction of the post.

50. The connecting system of claim 49, wherein the attachment member includes a locking mechanism selectively engageable to restrict movement of the stud relative to the retainer in a direction perpendicular to the post.

51. The connecting system of claim 50, wherein the connecting portion defines a recess in the receptacle, and wherein the locking mechanism includes a pin extending outwardly from the stud head and engageable with the recess to retain the stud in the receptacle, the pin being movable relative to the stud between a pin locked position, in which the pin extends into the recess so that the stud is secured in the receptacle, and a pin unlocked position, in which the pin is retracted from the recess so that the stud is removable from the receptacle.

52. The connecting system of claim 51, wherein the pin is biased toward the pin locked position, the locking mechanism including a release mechanism actuatable to move the pin toward the pin unlocked position.

53. The connecting system of claim 52, wherein the release mechanism includes a lever movable between a lever locked position, in which the pin is in the pin locked position, and a lever unlocked position, in which the pin is in the pin locked position, the lever being biased toward the lever locked position.

54. The connecting system of claim 53, wherein the lever includes a release slot aligned with the stud and a cam adjacent the release slot, the cam having a lock portion and an unlock portion, wherein the pin extends through the release slot and through the stud and has a pin head extending radially outwardly from an end of the pin adjacent the release slot, the pin head being engageable with the cam, wherein, in the pin locked position, the pin head engages the lock portion of the cam, and wherein, in the pin unlocked position, the pin head engages the unlock portion of the cam.

55. The connecting system of claim 44, wherein the attachment member includes a clip connectable to a support to support the power tool on the support.

56. The connecting system of claim 55, wherein the attachment member is a belt clip, and wherein the support is a work belt.

57. The connecting system of claim 55, wherein the attachment member includes a body, wherein the clip includes a clip surface provided by the body, a clip jaw connected to the body and movable relative to the clip surface, and an extension pin connected to the clip jaw and movably supported by the body, the support being receivable between the clip surface and the clip jaw to connect the attachment member to the support.

58. The connecting system of claim 57, wherein the clip includes a clip locking mechanism selectively engageable with the extension pin to restrict movement of the clip jaw relative to the clip surface.

59. The connecting system of claim 58, wherein the clip locking mechanism includes a clip release mechanism having a wedge movable relative to the body between a wedging position, in which the wedge engages the extension pin to restrict movement of the extension pin relative to the body, and an unwedged position, in which the wedge is disengaged from the extension pin and the extension pin is movable relative to the body, the wedge being biased toward the wedged position.

60. The connecting system of claim 44, wherein the attachment member includes a body and a mounting bracket connected to the body and connectable to a support to support the power tool on the support.

61. The connecting system of claim 60, wherein the connecting portion defines a recess in the receptacle, wherein the stud has a post and a stud head disposed at an end of the post opposite the body and extending radially from the post, the stud having a pin at least partially disposed within the stud and extending from the stud head, the pin being engageable with the recess to retain the stud within the retainer.

62. The connecting system of claim 61, wherein the pin is fixed relative to the mounting bracket, and the stud is movable relative to the mounting bracket between a pin locked position, in which the pin engages the recess to restrict movement of the stud relative to the receptacle, and a pin unlocked position, in which the pin is disengaged from the recess to allow movement of the stud relative to the receptacle.

63. The connecting system of claim 44, wherein the power tool includes a second connecting portion disposed on a side of power tool opposite from the first-mentioned connecting portion, the second connecting portion defining a second leg aperture and a second fastener aperture, wherein the connecting system further comprises a second retainer removably connectable with the power tool adjacent the second connecting portion, the second retainer including a second leg extending from the second retainer and insertable into the second leg aperture and a second fastener receivable into the second fastener aperture, the second fastener being pivotable relative to the second fastener aperture between a locked position, in which the second retainer is connected to the power tool, and an unlocked position, in which the second retainer is removable from the power tool, and wherein the attachment member is selectively and alternatively engageable with the first-mentioned retainer and the second retainer to removably connect the power tool and the attachment member.

64. A connecting system comprising:
a power tool including a connecting portion and defining a first leg aperture, a second leg aperture, and a locking aperture;
a power tool accessory removably connectable with the power tool adjacent the connecting portion and at least partially defining a receptacle with the connecting portion, the accessory including a body, a first leg projecting from the body and insertable into the first leg aperture, a second leg extending from the body and insertable into the second leg aperture, and a locking member projecting from the body and insertable into the locking aperture, the accessory being movable in a direction substantially parallel to the connecting portion between a locked position, in which the locking member is secured in the locking aperture to connect the accessory and the power tool, and an unlocked position, in which the locking member is removable from the locking aperture; and
a spring supportable on the connecting portion and engageable with at least one of the first leg and the second leg to bias the accessory toward the locked position.

65. The connecting system of claim 64, wherein the locking aperture includes a slot having a locking portion and an unlocking portion, wherein, when the accessory is in the unlocked position, the locking member is in the unlocking portion of the locking aperture, and wherein, when the accessory is in the locked position, the locking member is in the locking portion of the locking aperture.

66. The connecting system of claim 65, wherein the locking aperture has a slot width, the slot width of the unlocking portion being greater than the slot width of the locking portion, and wherein the locking member includes a shaft extending from the component, and a shaft head disposed at an end of the shaft opposite the accessory and wider than the shaft, the shaft head having a head width greater than the slot width of the locking portion, the shaft head being unable to pass through the locking portion of the slot.

67. The connecting system of claim 64, wherein the accessory includes a bit holder.

68. The connecting system of claim 64, wherein the accessory includes a bubble level.

69. The connecting system of claim 64, wherein the accessory includes a light.

70. A method of selectively connecting a power tool and a component, the power tool including a connecting portion having a leg aperture and a locking aperture, the component having a leg and a locking member, the method comprising the acts of:
inserting the leg into the leg aperture;
pivoting the component relative to the power tool;
inserting the locking member into the locking aperture; and
sliding the component in a direction substantially parallel to the connecting portion between an unlocked position, in which the locking member is removable from the locking aperture, and a locked position, in which the locking member is secured within the locking aperture.

71. The method of claim 70, wherein the component includes a retainer defining a receptacle, the connecting portion including a recess within the receptacle, wherein the method further comprises the acts of:
providing an attachment member having a body, a stud extending from the body, and a pin projectable from the stud, the pin being movable relative to the stud;
inserting the stud into the receptacle to connect the attachment member to the retainer and the power tool; and
extending the pin from the stud into the recess to secure the stud in the receptacle.

72. The method of claim 71, further comprising the acts of:
providing a release mechanism on the attachment member, the release mechanism having a lever engaging the pin and being operable to move the pin relative to the stud;
actuating the lever to retract the pin into the stud and remove the pin from the recess; and
removing the stud from the receptacle.
